(19) United States
(12) Patent Application Publication
(10) Pub. No.: US 2025/0035434 A1
(43) Pub. Date: Jan. 30, 2025

(54) MEASUREMENT SYSTEM AND MEASUREMENT METHOD

(71) Applicant: Panasonic Intellectual Property Management Co., Ltd., Osaka (JP)

(72) Inventors: AKIRA HASHIYA, Osaka (JP); YASUHISA INADA, Osaka (JP)

(21) Appl. No.: 18/916,777

(22) Filed: Oct. 16, 2024

Related U.S. Application Data
(63) Continuation of application No. PCT/JP2023/015843, filed on Apr. 21, 2023.

(30) Foreign Application Priority Data
May 13, 2022 (JP) 2022-079310
Mar. 8, 2023 (JP) 2023-035884

(51) Int. Cl. G01B 11/30

(52) U.S. Cl. CPC G01B 11/303

(57) ABSTRACT

A measurement system includes a light source, an optical detector, and a processing circuit. The light source emits irradiation light to be applied to multiple measurement points included in at least one evaluation region of a surface of an object. The optical detector receives reflected light returned from the multiple measurement points and outputs a detection signal. The processing circuit calculates and outputs a roughness parameter regarding an uneven shape of the at least one evaluation region, based on the detection signal. The processing circuit corrects the roughness parameter in accordance with an angle of incidence of the irradiation light incident on the at least one evaluation region, a measurement distance in the at least one evaluation region, or intensity of received light obtained as a result of the at least one evaluation region being irradiated with the irradiation light.

### BACKGROUND

### 1. Technical Field

The present disclosure relates to a measurement system and a measurement method.

### 2. Description of the Related Art

It is desired that the uneven shape of an object be precisely measured. Examples of such an object are a structure in a construction site and a large product manufactured in a factory, such as a vehicle.

To measure the uneven shape of an object, a contact measurement system using a probe and a non-contact measurement system using irradiation light are available. For a large object, the contact measurement system needs a long time to measure the shape of the object. In contrast, even for a large object, the non-contact measurement system needs a shorter time to measure the shape of the object. If the measurement precision in the non-contact measurement system is improved, the uneven shape of an object can be measured more precisely in a short time. Japanese Unexamined Patent Application Publication No. 2018-72042 discloses that the surface shape of a tire tread pattern is measured with the non-contact measurement system.

### SUMMARY

One non-limiting and exemplary embodiment provides a measurement system and a measurement method that can measure an uneven shape of an object more precisely.

In one general aspect, the techniques disclosed here feature a measurement system including: a light source that emits irradiation light to be applied to multiple measurement points included in at least one evaluation region of a surface of an object; an optical detector that receives reflected light returned from the multiple measurement points and outputs a detection signal; and a processing circuit that calculates and outputs a roughness parameter regarding an uneven shape of the at least one evaluation region, based on the detection signal. The processing circuit corrects the roughness parameter in accordance with an angle of incidence of the irradiation light incident on the at least one evaluation region, a measurement distance in the at least one evaluation region, or intensity of received light obtained as a result of the at least one evaluation region being irradiated with the irradiation light.

Using the technology of the disclosure makes it possible to implement a measurement system and a measurement method that can measure an uneven shape of an object more precisely.

It should be noted that general or specific embodiments may be implemented as a system, a device, a method, an integrated circuit, a computer program, a computer-readable recording medium, such as a recording disc, or any selective combination thereof. The computer-readable recording medium may include a non-volatile recording medium, such as a compact disc-read only memory (CD-ROM). The device may be constituted by one or more devices. If the device is constituted by two or more devices, they may be disposed within one machine or may be separately distributed to two or more machines. In the specification and claims, a device may mean one device or may mean a system constituted by plural devices.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view illustrating a state in which a roughness parameter regarding the uneven shape of an object is being measured;

FIG. 2A schematically illustrates the distribution of multiple measurement points in a first evaluation region;

FIG. 2B schematically illustrates the distribution of multiple measurement points in a second evaluation region;

FIG. 3 is a block diagram schematically illustrating the configuration of a measurement system according to a first embodiment of the disclosure;

FIG. 4A schematically illustrates the relationships between a reference surface, arithmetic mean height, and root mean square height in an evaluation region having an uneven shape;

FIG. 4B schematically illustrates an example of the reference surface of the uneven shape having waviness with low frequencies;

FIG. 4C schematically illustrates another example of the reference surface of the uneven shape having waviness with low frequencies;

FIG. 5A is a graph illustrating the relationship between the angle of incidence of light and a roughness parameter;

FIG. 5B illustrates an example of correction data stored in a storage;

FIG. 5C illustrates another example of correction data stored in the storage;

FIG. 6 is a flowchart schematically illustrating an example of correction data generating processing executed by a processing circuit in the first embodiment;

FIG. 7 is a flowchart schematically illustrating an example of roughness parameter measurement processing executed by the processing circuit in the first embodiment;

FIG. 8 is a flowchart schematically illustrating an example of correction data generating processing executed by the processing circuit in a second embodiment;

FIG. 9 is a flowchart schematically illustrating an example of roughness parameter measurement processing executed by the processing circuit in the second embodiment;

FIG. 10 is a flowchart schematically illustrating an example of roughness parameter measurement processing executed by the processing circuit in a third embodiment;

FIG. 11 is a flowchart schematically illustrating an example of roughness parameter measurement processing executed by the processing circuit in a fourth embodiment;

FIG. 12 is a flowchart schematically illustrating an example of correction data generating processing executed by the processing circuit in a fifth embodiment;

FIG. 13 is a flowchart schematically illustrating an example of roughness parameter measurement processing executed by the processing circuit in the fifth embodiment;

FIG. 14 is a flowchart schematically illustrating an example of correction data generating processing executed by the processing circuit in a sixth embodiment;

FIG. 15 is a flowchart schematically illustrating an example of roughness parameter measurement processing executed by the processing circuit in the sixth embodiment;

FIG. 16 is a flowchart schematically illustrating an example of roughness parameter measurement processing executed by the processing circuit in a seventh embodiment;

FIG. 17 is a flowchart schematically illustrating an example of roughness parameter measurement processing executed by the processing circuit in an eighth embodiment;

FIG. 18A is a flowchart schematically illustrating an example of evaluation processing for a surface unevenness degree executed by the processing circuit in a ninth embodiment;

FIG. 18B is a block diagram schematically illustrating an example of a flow of data input and generated in the evaluation processing for a surface unevenness degree;

FIG. 19A is a block diagram schematically illustrating an example of the configuration of an FMCW-LiDAR range-finding device;

FIG. 19B is a block diagram schematically illustrating an example of the configuration of an optical interference system shown in FIG. 19A;

FIG. 20 is a block diagram schematically illustrating an example of the configuration of an FMCW-LiDAR measurement system including an integrated processing circuit;

FIG. 21 is a block diagram schematically illustrating an example of the configuration of a TOF range-finding device; and

FIG. 22 is a block diagram schematically illustrating an example of the configuration of a TOF measurement system including an integrated processing circuit.

### DETAILED DESCRIPTIONS

In the present disclosure, some or all of the circuits, units, devices, members, or sections or some or all of the functional blocks in the block diagrams may be implemented by one or plural electronic circuits including a semiconductor device, a semiconductor integrated circuit (IC), or a large scale integration (LSI) circuit. An LSI or an IC may be integrated into one chip or be distributed over multiple chips. For example, the functional blocks other than storage elements may be integrated into one chip. An LSI or an IC may be called a system LSI, a very large scale integration (VLSI) circuit, or an ultra large scale integration (ULSI) circuit, depending on the integration degree. Instead of an LSI or an IC, a field programmable gate array (FPGA) that is programmable after it is manufactured, or a reconfigurable logic device that may reconfigure connections or settings of circuit cells within this device may be used for the same purpose.

The functions or operations of some or all of the circuits, units, devices, members, or sections may be executed by software. In this case, software is recorded on one or plural non-transitory recording media, such as read only memories (ROMs), optical discs, and hard disk drives. When the software is executed by a processor, the functions specified by this software are executed by the processor and a peripheral device. The system or the device may include one or plural non-transitory recording media having software recorded thereon, a processor, and a desirable hardware device, such as an interface.

In the disclosure, “light” includes, not only visible light (wavelengths of about 400 to 700 nm), but also electromagnetic waves, such as ultraviolet light (wavelengths of about 10 to 400 nm) and infrared light (wavelengths of about 700 nm to 1 mm).

Embodiments of the disclosure will be described below with reference to the accompanying drawings. The embodiments described below illustrate general or specific examples. The numeric values, configurations, components, positions and connection states of the components, steps, and the order of steps illustrated in the following embodiments are only examples, and are not described to limit the disclosure. Among the components illustrated in the following embodiments, the components that are not recited in the independent claims which embody the broadest concept of the disclosure will be described as optional components.

In the drawings, the components are only schematically illustrated and are not necessarily illustrated precisely. The substantially same components are designated by like reference numeral, and the same explanation thereof may be simplified or omitted from the second time.

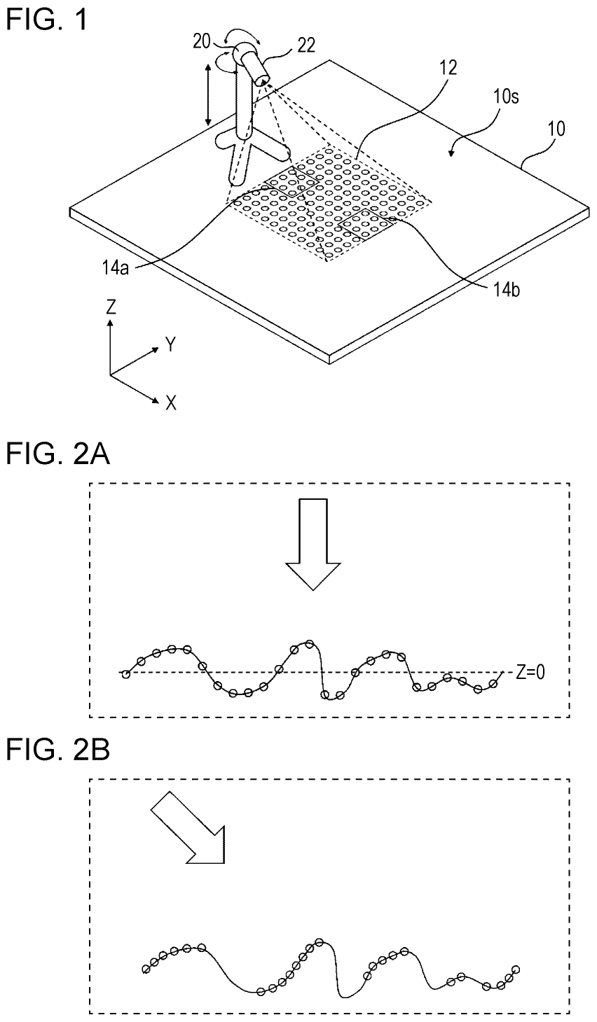

Before describing the embodiments of the disclosure, underlying knowledge forming the basis of the disclosure will be explained below with reference to FIGS. 1 through 2B. FIG. 1 is a schematic view illustrating a state in which a roughness parameter regarding the uneven shape of an object is being measured. The X axis, Y axis, and Z axis shown in FIG. 1 are perpendicular to each other.

In FIG. 1, an object 10 having a surface 10s extending in an XY plane is shown. The object 10 is large and the surface 10s has several square meters. The surface 10s of the object 10 has an irregular uneven shape, and the irregularities of the uneven shape are substantially uniform regardless of the position of the surface 10s.

In FIG. 1, a support 20 placed on the object 10 and an optical head 22 supported by the support 20 are also shown. The support 20 includes a tripod, a stretchable rod attached to the top of the tripod, and a rotatable sphere secured to the top of the rod. The support 20 supports the optical head 22 by the sphere. The stretchable rod can adjust the height of the optical head 22 in the up-down direction. The rotatable sphere can adjust the orientation of the optical head 22 in the pan and/or tilt directions. The double-headed arrow indicated by the straight line in FIG. 1 represents the adjustable direction of the height of the optical head 22. The double-headed arrows indicated by the curved lines in FIG. 1 represent the adjustable directions of the orientation of the optical head 22. The height of the optical head 22 from the surface 10s of the object 10 is greater than or equal to 50 cm and less than or equal to 3 m, for example. The height of the optical head 22 from the surface 10s of the object 10 is the height of the center of the light exit plane of the optical head 22, through which irradiation light is output, from the surface 10s of the object 10.

The optical head 22 contains an optical deflector therein and is able to scan irradiation light by using the optical deflector. In a state in which the optical head 22 faces part of the surface 10s of the object 10, irradiation light is output from a range-finding device, which is not shown, via the optical head 22 while being two-dimensionally scanned by the optical deflector. A range-finding region 12 shown in FIG. 1 is a region of the surface 10s of the object 10 that can be irradiated with the irradiation light. The range-finding region 12 is a rectangular region defined by the dotted lines in FIG. 1. The range-finding device measures the distances of multiple measurement points included in the range-finding region 12 and generates distance information of each of the multiple measurement points. The circles in FIG. 1 represent the measurement points. The distance information of each measurement point may be information on the distance from the center of the light exit plane of the optical head 22 to the corresponding measurement point. As for the density of the measurement points, the number of measurement points is larger than or equal to 10³/m² and smaller than or equal to 10⁷/m², for example.

In the example in FIG. 1, a first evaluation region 14a and a second evaluation region 14b, which will be discussed below, are extracted from the range-finding region 12. The first evaluation region 14a is a region irradiated with irradiation light which is incident on the first evaluation region 14a substantially vertically. The angle of incidence θ of this irradiation light is almost 0°. The second evaluation region 14b is a region irradiated with irradiation light which is incident on the second evaluation region 14b obliquely. The angle of incidence θ of this irradiation light is substantially 45°. The angle of incidence θ is the angle between the optical axis of irradiation light and a line normal to the surface 10s of the object 10. Issues that arise when the roughness parameters in the first and second evaluation regions 14a and 14b are measured will be discussed below.

FIG. 2A schematically illustrates the distribution of multiple measurement points in the first evaluation region 14a. FIG. 2B schematically illustrates the distribution of multiple measurement points in the second evaluation region 14b. For easy understanding, it is assumed that the uneven shapes of the first and second evaluation regions 14a and 14b are the same. The white arrows in FIGS. 2A and 2B schematically illustrate the directions in which irradiation light is incident. The circles in FIGS. 2A and 2B indicate the measurement points.

In the example in FIG. 2A, the measurement points are distributed substantially uniformly in the first evaluation region 14a regardless of the presence or the absence of projecting portions and recessed portions of the uneven shape. The correct heights of the projecting portions and the recessed portions of the uneven shape in the first evaluation region 14a can thus be obtained from the items of distance information of the individual measurement points, and the roughness parameter in the first evaluation region 14a can be measured precisely. As the roughness of the projecting portions and recessed portions is greater, the value of the roughness parameter becomes larger.

In contrast, in the example in FIG. 2B, the measurement points in the second evaluation region 14b are distributed in the area which is exposed to light and are not distributed in the area which is not exposed to light. This makes it difficult to obtain the correct heights of the projecting portions and the recessed portions of the uneven shape from the items of distance information of the individual measurement points in the second evaluation region 14b. The roughness parameter in the second evaluation region 14b should be substantially equal to that in the first evaluation region 14a. In actuality, however, the roughness parameter in the second evaluation region 14b becomes smaller than that in the first evaluation region 14a. In this manner, it may not be possible to correctly measure the roughness parameter, depending on the angle of incidence of irradiation light.

Additionally, the roughness parameter is also dependent on factors other than the angle of incidence of irradiation light, such as the measurement distance in the first and second evaluation regions 14a and 14b and the intensity of received light obtained as a result of the first and second evaluation regions 14a and 14b being irradiated with the irradiation light. As the measurement distance is longer, the measurement error of the roughness parameter is increased. As the intensity of light is weaker, the measurement error of the roughness parameter is increased.

The present inventor has found out the above-described issues and has attained a measurement system and a measurement method according to an embodiment of the disclosure to address the issues. In the measurement system and the measurement method according to the embodiment, the roughness parameter in the evaluation region is corrected in accordance with the angle of incidence of irradiation light, thereby making it possible to measure the uneven shape of the object more precisely. Additionally, a factor other than the angle of incidence of irradiation light can also be considered. For example, the roughness parameter in the evaluation region is corrected in accordance with the measurement distance in the evaluation region or the intensity of received light obtained as a result of the evaluation region irradiated with irradiation light, thereby making it possible to measure the uneven shape of the object more precisely. Furthermore, a learned model is used to evaluate the uneven shape of the object in the evaluation region, thereby making it possible to measure the uneven shape of the object more precisely.

The measurement system and the measurement method according to the embodiments of the disclosure will be described below.

A measurement system according to a first aspect includes: a light source that emits irradiation light to be applied to multiple measurement points included in at least one evaluation region of a surface of an object; an optical detector that receives reflected light returned from the multiple measurement points and outputs a detection signal; and a processing circuit that calculates and outputs a roughness parameter regarding an uneven shape of the at least one evaluation region, based on the detection signal. The processing circuit corrects the roughness parameter in accordance with an angle of incidence of the irradiation light incident on the at least one evaluation region, a measurement distance in the at least one evaluation region, or intensity of received light obtained as a result of the at least one evaluation region being irradiated with the irradiation light.

In this measurement system, the uneven shape of an object can be measured more precisely.

According to a measurement system in a second aspect, in the measurement system according to the first aspect, the roughness parameter is one of an arithmetic mean height, root mean square height, developed interfacial area ratio, skewness, kurtosis, and root mean square slope in a two-dimensional region or one of the arithmetic mean height, root mean square height, skewness, kurtosis, and root mean square slope in a linear region.

In this measurement system, the roughness parameter in a two-dimensional region or in a linear region can be measured.

According to a measurement system in a third aspect, in the measurement system according to the first or second aspect, the at least one evaluation region includes plural evaluation regions. The processing circuit corrects the roughness parameter in each of the plural evaluation regions in accordance with the angle of incidence of the irradiation light incident on a corresponding one of the plural evaluation regions.

In this measurement system, the roughness parameter in each of plural evaluation regions can be measured.

In the measurement system according to one of the first through third aspects, a measurement system according to a fourth aspect further includes an optical deflector that changes a direction of the irradiation light. The processing circuit controls an operation of the optical deflector.

In this measurement system, irradiation light can be emitted while being scanned.

According to a measurement system in a fifth aspect, in the measurement system according to one of the first through fourth aspects, before the irradiation light is emitted, the processing circuit calculates the angle of incidence of the irradiation light based on a result of distance measurement for the surface of the object.

In this measurement system, when the angle between the surface of the object and the reference surface is unknown, the angle of incidence of irradiation light can be calculated.

According to a measurement system in a sixth aspect, in the measurement system according to one of the first through fifth aspects, the processing circuit obtains correction data from a storage. The correction data is data that defines a correlation between an angle of incidence and a correction parameter. The processing circuit determines a correction parameter based on the angle of incidence of the irradiation light and the correction data. The processing circuit corrects the roughness parameter based on the determined correction parameter.

In this measurement system, the roughness parameter can be corrected based on correction data.

According to a measurement system in a seventh aspect, in the measurement system according to the sixth aspect, the correction data is stored in the storage by object attribute. The processing circuit obtains the correction data from the storage, based on an attribute of the object to be measured.

In this measurement system, the roughness parameter can be corrected based on the attribute of an object.

According to a measurement system in an eighth aspect, in the measurement system according to the seventh aspect, the attribute of the object is at least one of a material, a proportion of the material, a size, a polishing method for the surface, or a product number of the object.

In this measurement system, the roughness parameter can be corrected based on at least one of the above-described attributes.

According to a measurement system in a ninth aspect, in the measurement system according to one of the first through eighth aspects, when the incidence of angle is larger than a reference angle for correction, the processing circuit sets a greater correction amount for the roughness parameter as the angle of incidence is larger. When the incidence of angle is smaller than the reference angle for correction, the processing circuit sets a greater correction amount for the roughness parameter as the angle of incidence is smaller.

In this measurement system, the roughness parameter can be corrected based on the difference between the angle of incidence of irradiation light and the reference angle for correction.

According to a measurement system in a tenth aspect, in the measurement system according to one of the first through ninth aspects, the processing circuit outputs the roughness parameter which has not yet been corrected, as well as the corrected roughness parameter.

In this measurement system, the corrected roughness parameter and the roughness parameter which has not yet been corrected can be displayed on a display.

According to a measurement system in an eleventh aspect, in the measurement system according to one of the first through tenth aspects, the processing circuit includes first and second processing circuits. The first processing circuit generates distance information on each of the multiple measurement points, based on the detection signal. The second processing circuit calculates the roughness parameter regarding the uneven shape of the at least one evaluation region, based on the distance information. The second processing circuit corrects the roughness parameter in accordance with the angle of incidence of the irradiation light incident on the at least one evaluation region.

In this measurement system, the processing circuit that generates distance information on each of the multiple measurement points and the processing circuit that calculates the roughness parameter and corrects it are independent of each other.

A measurement method according to a twelfth aspect is a measurement method to be executed by a computer in a measurement system. The measurement system includes a light source and an optical detector. The light source emits irradiation light to be applied to multiple measurement points included in an evaluation region of a surface of an object. The optical detector receives reflected light returned from the multiple measurement points and outputs a detection signal. The measurement method includes: calculating and outputting a roughness parameter regarding an uneven shape of the evaluation region, based on the detection signal; and correcting the roughness parameter in accordance with an angle of incidence of the irradiation light incident on the evaluation region.

In this measurement method, the uneven shape of an object can be measured more precisely.

A measurement system according to a thirteenth aspect includes: a light source that emits irradiation light to be applied to multiple measurement points included in an evaluation region of a surface of an object; an optical detector that receives reflected light returned from the multiple measurement points and outputs a detection signal; and a processing circuit that calculates and outputs a surface unevenness degree regarding an uneven shape of the evaluation region, based on the detection signal. The processing circuit generates a learned model by using, as training data, an angle of incidence of the irradiation light incident on a reference region, the detection signal, and the surface unevenness degree regarding an uneven shape of the reference region. The processing circuit evaluates the surface unevenness degree in the evaluation region by using the learned model.

In this measurement system, the uneven shape of an object can be measured more precisely.

According to a measurement system in a fourteenth aspect, in the measurement system according to the thirteenth aspect, the reference region is one of multiple different regions of the surface of the object or one of multiple virtual regions corresponding to multiple angles of incidence.

In this measurement system, a learned model can be generated by setting a suitable reference region.

According to a measurement system in a fifteenth aspect, in the measurement system according to the thirteenth or fourteenth aspect, the evaluation region is a two-dimensional region or a linear region.

In this measurement system, the surface unevenness degree in a two-dimension region or a linear region can be evaluated.

According to a measurement system in a sixteenth aspect, in the measurement system according to one of the first through fifteenth aspects, based on the detection signal, the processing circuit sets the angle of incidence of the irradiation light incident on the at least one evaluation region, the measurement distance in the at least one evaluation region, or the intensity of received light obtained as a result of the at least one evaluation region being irradiated with the irradiation light.

In this measurement system, initial measurement for calculating the angle of incidence, the measurement distance, or the intensity of received light is not necessary, thereby making it possible to measure the uneven shape of an object in a shorter time.

A measurement system according to a seventeenth aspect includes: a light source that emits irradiation light to be applied to multiple measurement points included in at least one evaluation region of a surface of an object; an optical detector that receives reflected light returned from the multiple measurement points and outputs a detection signal; and a processing circuit that calculates and outputs a roughness parameter regarding an uneven shape of the at least one evaluation region, based on the detection signal. The processing circuit corrects a reference value used for evaluating the calculated roughness parameter in accordance with an angle of incidence of the irradiation light incident on the at least one evaluation region, a measurement distance in the at least one evaluation region, or intensity of received light obtained as a result of the at least one evaluation region being irradiated with the irradiation light. The processing circuit outputs a result of comparison between the calculated roughness parameter and the corrected reference value.

In this measurement system, the uneven shape of an object can be measured more precisely.

### First Embodiment

### [Measurement System]

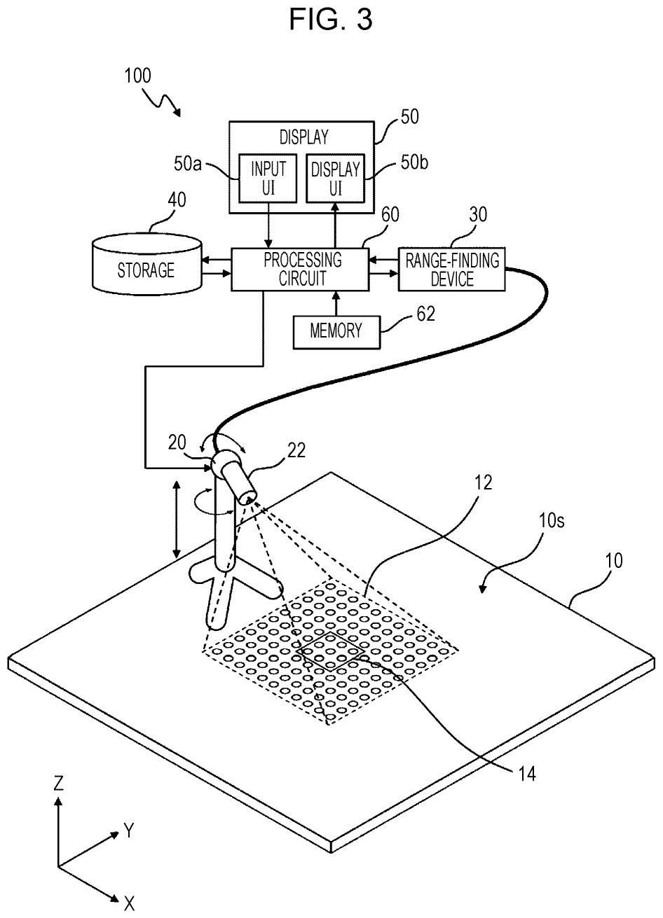

An example of the configuration of a measurement system according to a first embodiment of the disclosure will be described below with reference to FIG. 3. FIG. 3 is a block diagram schematically illustrating the configuration of a measurement system 100 according to the first embodiment of the disclosure. The measurement system 100 shown in FIG. 3 includes a support 20, an optical head 22 supported by the support 20, a range-finding device 30, a storage 40, a display 50, a processing circuit 60, and a memory 62. The thin arrows in the block diagram of FIG. 3 indicate input/output of a signal. The thick curved line in FIG. 3 indicates an optical fiber coupling the range-finding device 30 and the optical head 22.

In addition to the measurement system 100, as in FIG. 1, FIG. 3 illustrates a state in which the roughness parameter in an evaluation region 14 of a surface 10s of an object 10 is being measured with irradiation light output from the optical head 22. In the example in FIG. 3, the evaluation region 14 is located at the center of a range-finding region 12 and is contained in the range-finding region 12. The evaluation region 14 is extracted from the range-finding region 12. The evaluation region 14 may not necessarily be the central area of the range-finding region 12 and may be any region in the range-finding region 12.

The evaluation region 14 is extracted from the range-finding region 12 when it is difficult to adjust the size of the range-finding region 12 that can be irradiated with light output from the optical head 22. In contrast, if it is possible to adjust the size of the range-finding region 12, it may be narrowed down to the size of the evaluation region 14.

In the measurement system 100, the processing circuit 60 calculates the roughness parameter in the evaluation region 14, based on the distance measurement result obtained by the range-finding device 30 using irradiation light. The processing circuit 60 also corrects the roughness parameter in accordance with the angle of incidence of irradiation light incident on the evaluation region 14, based on correction data stored in the storage 40. As a result, the uneven shape of the object 10 can be measured more precisely. Processing of the processing circuit 60 will be discussed later in detail.

Strictly speaking, the angle of incidence of irradiation light incident on the evaluation region 14 becomes different depending on the position in the evaluation region 14 at which the irradiation light is incident. In the specification, the typical angle of incidence of irradiation light incident on the evaluation region 14 will be used as the angle of incidence of the irradiation light. This typical angle of incidence may be the angle of incidence of irradiation light incident on the center of the evaluation region 14, for example. Alternatively, the typical angle of incidence may be the largest or the smallest one of the angles of incidence of irradiation light that can be incident on the evaluation region 14.

Details of the object 10 will be explained below, followed by a detailed explanation of the individual components of the measurement system 100.

### (Object 10)

The object 10 to be measured has a large size. The surface 10s of the object 10 may include a one square meter area, for example. The surface 10s of the object 10 may have an irregular uneven shape. The dimension in the X direction and/or the Y direction of projecting portions or recessed portions of the uneven shape of the surface 10s may be larger than or equal to 1 mm and smaller than or equal to 150 mm, for example. The dimension in the Z direction of the projecting portions or the recessed portions may be larger than or equal to 0.1 mm and smaller than or equal to 75 mm, for example.

The object 10 may be a structure in a construction site or a large product manufactured in a factory, for example. The structure may be formed from a concrete member, a metal member, or wood, for example. Examples of the factory products are vehicles, electric home appliances, and mechanical parts.

In the specification, a large object is used as an example of the object 10 to be measured. Depending on the purpose of use, however, a small or medium sized object may be used as the object 10 to be measured.

### (Support 20 and Optical Head 22)

The configurations of the support 20 and the optical head 22 are those as discussed above. The support 20 includes an adjuster that adjusts the height and/or the orientation of the optical head 22.

### (Range-Finding Device 30)

The range-finding device 30 includes a light source, an optical detector, an optical deflector, and a range-finding processing circuit. These components are not seen from the external side of the range-finding device 30. The optical deflector is stored within the optical head 22. The optical head 22 faces the range-finding region 12. The light source emits irradiation light to be applied to multiple measurement points included in the range-finding region 12. Since the evaluation region 14 is part of the range-finding region 12, it can be said that the light source emits irradiation light to be applied to multiple measurement points included in the evaluation region 14. The irradiation light emitted from the light source passes through the optical fiber and is then incident on the optical deflector. The optical deflector changes the direction of the irradiation light emitted from the light source. As a result, the irradiation light is output from the optical head 22 while being scanned. The irradiation light may be laser light or light-emitting diode (LED) light. The wavelength of the irradiation light may be determined by the above-described dimensions of the projecting portions or the recessed portions of the uneven shape of the surface 10s of the object 10, for example. The wavelength of the irradiation light may be that of visible light or that of ultraviolet light or infrared light. The optical detector receives light reflected by the measurement points and outputs a detection signal. The range-finding processing circuit controls the operations of the light source, optical detector, and optical deflector and generates and outputs distance information of each of the measurement points based on the detection signal. As discussed above, the distance information may be information on the distance from the center of the light exit plane of the optical head 22 to each measurement point, for example.

As described above, the range-finding device 30 measures the distance of each measurement point by using irradiation light which is output from the optical head 22 while being scanned, and generates and outputs distance information of each measurement point. Alternatively, if irradiation light has a wide irradiation range, the range-finding device 30 may measure the distances of multiple measurement points at one time by using irradiation light output from the optical head 22 without being scanned, and generate and output distance information of each measurement point. In this case, the provision of the optical deflector for the range-finding device 30 may be omitted.

The range-finding device 30 may be a FMCW-LiDAR (Frequency Modulated Continuous Wave-Light Detection And Ranging) range-finding device or a TOF (Time Of Flight) range-finding device, for example. The configuration and the distance measurement method of the range-finding device 30 will be discussed later in detail.

### (Storage 40)

The storage 40 stores correction data used for correcting the roughness parameter in accordance with the angle of incidence of irradiation light incident on the evaluation region 14. Details of the correction data will be discussed later. The storage 40 may be a hard disk drive (HDD) including a magnetic disk or a solid state drive (SSD) including a flash memory, for example.

### (Display 50)

The display 50 displays an input user interface (UI) 50a and a display UI 50b. The input UI 50a is used by a user to input information. The information input by the user into the input UI 50a is received by the processing circuit 60. Details of input information will be discussed later. The display UI 50b is used for displaying information generated by the processing circuit 60.

The input UI 50a and the display UI 50b are displayed as graphical user interfaces (GUIs). It can be said that information displayed on the input UI 50a and the display UI 50b is displayed on the display 50. The input UI 50a and the display UI 50b may be implemented by a device that can perform both of input and output operations, such as a touchscreen. In this case, the touchscreen may serve as the display 50. If a keyboard and/or a mouse is used as the input UI 50a, the input UI 50a is a separate device from the display 50.

### (Processing Circuit 60)

The processing circuit 60 controls the operations of the adjuster of the support 20, range-finding device 30, storage 40, and display 50. The processing circuit 60 calculates the roughness parameter in the evaluation region 14, based on distance information output from the range-finding device 30. The processing circuit 60 also obtains correction data from the storage 40 or an external storage, such as a server, and corrects the roughness parameter in accordance with the angle of incidence of irradiation light incident on the evaluation region 14, based on the obtained correction data. If the processing circuit 60 obtains the correction data from an external storage, the provision of the storage 40 can be omitted. The processing circuit 60 also outputs the corrected roughness parameter and displays it on the display UI 50b.

Details of correction data generating processing and roughness parameter measurement processing executed by the processing circuit 60 will be discussed later. A computer program executed by the processing circuit 60 is stored in the memory 62, such as a read only memory (ROM) or a random access memory (RAM). In this manner, the measurement system 100 is provided with a processor including the processing circuit 60 and the memory 62. The processing circuit 60 and the memory 62 may be integrated on one circuit substrate or be provided on different circuit substrates. The processing circuit 60 may be distributed over plural circuits. The processing circuit 60, the memory 62, or the processor may be installed in a remote place separated from the other components of the measurement system 100 via a wired or wireless communication network.

In the example in FIG. 3, the range-finding processing circuit included in the range-finding device 30 and the processing circuit 60 are provided as separate devices, but they may be integrated into each other and be treated as one processing circuit. In the specification, the range-finding processing circuit included in the range-finding device 30 is also called a first processing circuit, while the processing circuit 60 is also called a second processing circuit. It can thus be said that the integrated processing circuit includes the first and second processing circuits.

### [Examples of Roughness Parameter]

Examples of the roughness parameter in the evaluation region will be discussed below. The size of the evaluation region may be determined in accordance with the dimensions of projecting portions or recessed portions of the uneven shape of the surface 10s of the object 10 in the X direction, Y direction, and Z direction. The evaluation region is a two-dimensional region or a linear region.

### (Two-Dimensional Evaluation Region)

The evaluation region may be a two-dimensional region, such as a rectangle, a circle, or an ellipse. The two-dimensional evaluation region is effectively used for an object 10 having a surface 10s with an uneven shape in which projecting portions and recessed portions are distributed two-dimensionally.

One example of the roughness parameter is the arithmetic mean height Sa. The arithmetic mean height Sa can be calculated by the following expression (1).

$${S}_{a} = \frac{1}{A} {\int }_{A} \vert Z ( x , y ) \vert dxdy \qquad ( 1 )$$

In expression (1), Z(x, y) denotes a height difference of projecting portions and recessed portions measured from the reference surface Z=0 at a position X=x and Y=y within the evaluation region. The reference surface Z=0 is the average surface between the heights of the projecting portions and the recessed portions within the evaluation region. In expression (1), “A” denotes the area of the evaluation region. The arithmetic mean height Sa is the value obtained by averaging the absolute values of the height differences of the projecting portions and the recessed portions measured from the reference surface Z=0 within the evaluation region. The heights of the projecting portions and the recessed portions can be obtained from the distance information of each of the measurement points.

Another example of the roughness parameter is the root mean square height Sq. The root mean square height Sq can be calculated by the following expression (2).

$${S}_{q} = \sqrt{\frac{1}{A} {\int }_{A} {Z}^{2} ( x , y ) dxdy} \qquad ( 2 )$$

The root mean square height Sq is represented by the root of the averaged value of the squares of the height differences of the projecting portions and the recessed portions measured from the reference surface Z=0 within the evaluation region. The root mean square height Sq corresponds to the standard deviation of the height differences in the evaluation region and represents variations in the height differences. The root mean square height Sq and the arithmetic mean height Sa satisfy the relationship Sq>Sa. As the variations in the height difference are greater, Sq/Sa deviates from 1 by a greater amount.

Other examples of the roughness parameter are the developed interfacial area ratio Sdr, which is an index of the surface area, the skewness Ssk, which represents the symmetry of the distribution of the heights of projecting portions and recessed portions, the kurtosis Sku, which represents the tailedness of the distribution of the heights of projecting portions and recessed portions, and the root mean square slope Sdq, which indicates the gradient of projecting portions and recessed portions.

As described above, the roughness parameter may be one of the arithmetic mean height Sa, root mean square height Sq, developed interfacial area ratio Sdr, skewness Ssk, kurtosis Sku, and root mean square slope Sdq in a two-dimensional region.

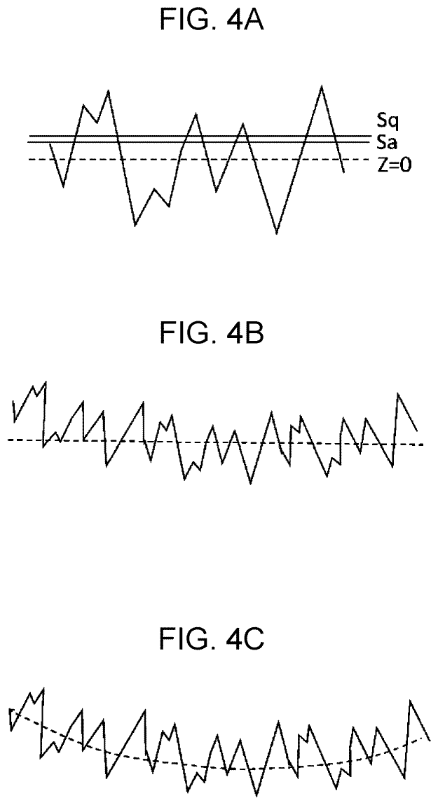

Examples of the arithmetic mean height Sa and the root mean square height Sq and an example of the reference surface in an evaluation region having an uneven shape will be discussed below with reference to FIGS. 4A through 4C. FIG. 4A schematically illustrates the relationships between the reference surface Z=0, arithmetic mean height Sa, and root mean square height Sq in an evaluation region having an uneven shape. In FIG. 4A, the broken line indicates the reference surface, and the solid lines indicate the arithmetic mean height Sa and the root mean square height Sq. In the example in FIG. 4A, Sq/Sa>1, and there are some variations in the height differences of projecting portions and recessed portions of the uneven shape measured from the reference height Z=0.

As illustrated in FIG. 4A, if the uneven shape does not have waviness, the reference surface Z=0 is a flat surface. In contrast, if the uneven shape has waviness with low frequencies, the reference surface may be defined as follows. FIGS. 4B and 4C schematically illustrate examples of the reference surface of the uneven shape having waviness with low frequencies. In the example in FIG. 4B, the reference surface is a flat surface obtained by averaging the heights of the projecting portions and the recessed portions in the evaluation region. If the reference surface is a flat surface, the roughness parameter including the waviness is calculated. In contrast, in the example in FIG. 4C, the reference surface is a curved surface obtained in the following manner. The evaluation region is divided into multiple regions. The heights of the projecting portions and the recessed portions in each region are averaged. Then, the averaged heights in the multiple regions are connected with each other, resulting in the curved surface. If the reference surface is a curved surface, the roughness parameter without the waviness is calculated.

### (Linear Evaluation Region)

The evaluation region may be a linear region, for example. The linear evaluation region is effectively used for an object 10 having a surface 10s of an uneven shape in which projecting portions and recessed portions are distributed linearly. The linear evaluation region may be a region parallel with a linear direction in which projecting portions and recessed portions are distributed or may be a region intersecting with this linear direction at an acute angle. The acute angle may be 30° or smaller, for example. Such a linear evaluation region may be applied to an object 10 having a surface 10s with an uneven shape in which projecting portions and recessed portions are distributed two-dimensionally.

The roughness parameter may be one of the arithmetic mean height Ra, root mean square height Rq, skewness Rsk, kurtosis Rku, and root mean square slope Rdq in a linear region.

### [Correction Method and Correction Data]

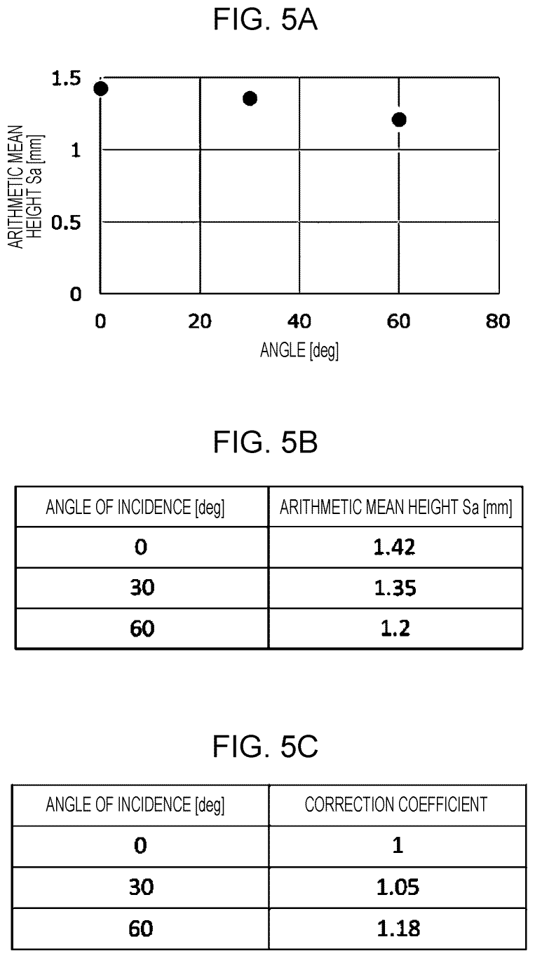

The relationship between the angle of incidence of irradiation light and a roughness parameter will now be explained below with reference to FIG. 5A. FIG. 5A is a graph illustrating the relationship between the angle of incidence of light and a roughness parameter. In the example in FIG. 5A, the evaluation region is a two-dimensional region, and the roughness parameter is the arithmetic mean height Sa. The angle of incidence θ is 0°, 30°, and 60°.

FIG. 5A shows that the arithmetic mean height Sa is decreased as the angle of incidence of irradiation light is increased. The reason for this is that, as explained with reference to FIG. 2B, when light is incident obliquely, the measurement points are not distributed in the area which is not exposed to light and the height difference of projecting portions and recessed portions measured from the reference surface Z=0 becomes smaller. For a similar reason, roughness parameters other than the arithmetic mean height Sa are also decreased as the angle of incidence of irradiation light is increased.

In the first embodiment, the roughness parameter is corrected in the following manner in accordance with the angle of incidence of irradiation light. Before the measurement of the roughness parameter is started, the distances of multiple measurement points of the surface 10s of the object 10 are measured with irradiation light incident at various angles θ, and based on the measurement results, the arithmetic mean heights SaO(θ) at various angles of incidence θ are calculated. Then, the measurement of the roughness parameter is started. By using irradiation light having an angle of incidence θ=α, the arithmetic mean height Sa(α) in the evaluation region is calculated. The calculated arithmetic mean height Sa(α) is corrected by the following expression (3).

$${S}^{′} a ( α ) = Sa ( α ) \times \{ Sa 0 ( β ) / Sa 0 ( α ) \} \qquad ( 3 )$$

In expression (3), S′a(α) denotes the corrected arithmetic mean height, and β is a reference angle for correcting the arithmetic mean height. In expression (3), α is a variable value and β is a fixed value. In the example in FIG. 5A, the angle of incidence θ at which the arithmetic mean height can be calculated most precisely is 0°. The reference angle β can thus be set to 0°. If the surface 10s of the object 10 has waviness, the angle of incidence θ at which the arithmetic mean height can be calculated most precisely may not be) 0° (θ≠0°. In this case, the reference angle β may not necessarily be 0° (β≠0°).

In expression (3), the calculated arithmetic mean height Sa (a) is multiplied by a correction coefficient SaO(β)/SaO(α) so as to obtain the corrected arithmetic mean height S′a(α). SaO(α) in expression (3) may be a measurement value, such as that in FIG. 5A, or may be a function fitted on a measurement value.

FIGS. 5B and 5C illustrate examples of correction data stored in the storage 40. In the example in FIG. 5B, the correction data is a table representing the correlation between the angle of incidence and the arithmetic mean height Sa. In the example in FIG. 5C, the correction data is a table representing the correlation between the angle of incidence and the correction coefficient. The angle of incidence is 0°, 30°, and 60° in the examples in FIGS. 5B and 5C, but the values and the number of angle of incidence are not limited to those shown in FIGS. 5B and 5C.

As described above, the correction data defines the correlation between the angle of incidence and the correction parameter. The correction parameter may be the roughness parameter, as shown in FIG. 5B, or may be the correction coefficient, as shown in FIG. 5C. If the angle of incidence is larger than the reference angle for correction, as the angle of incidence is larger, the correction amount of the roughness parameter becomes greater. If the angle of incidence is smaller than the reference angle for correction, as the angle of incidence is smaller, the correction amount of the roughness parameter becomes greater.

### [Correction Data Generating Processing]

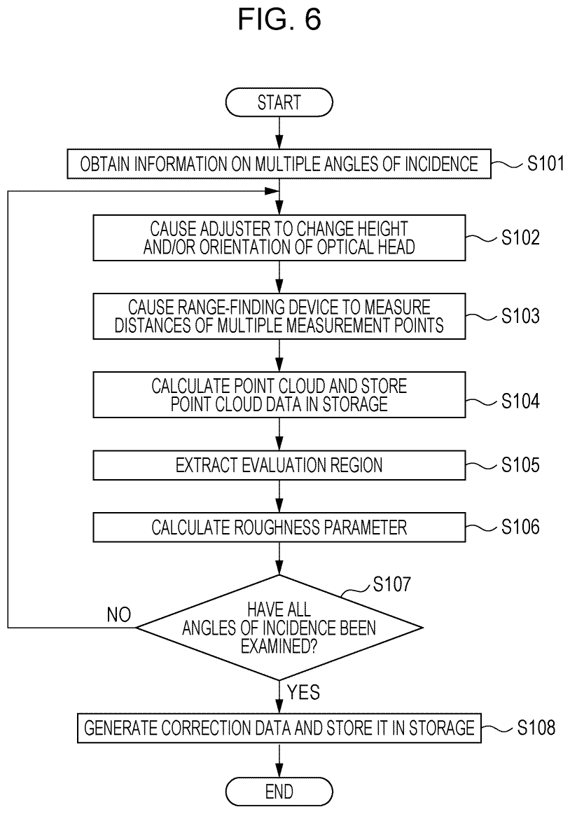

An example of correction data generating processing executed by the processing circuit 60 in the first embodiment will be described below with reference to FIG. 6. FIG. 6 is a flowchart schematically illustrating an example of correction data generating processing executed by the processing circuit 60 in the first embodiment. The processing circuit 60 executes steps S101 through S108 in FIG. 6.

### (Step S101)

A user inputs multiple angles of incidence used for correction data via the input UI 50a shown in FIG. 3. The processing circuit 60 obtains information on the multiple angles of incidence from the input UI 50a. The multiple angles of incidence may be set by changing the angle from a first angle to a second angle in increments of a certain value of angles, for example. The first angle may be 0°, for example. The second angle may be the angle of incidence of irradiation light that can illuminate a peripheral area of the surface 10a of the object 10, for example. The angle of incidence may be varied in increments of 5° or 10°, for example.

The user may also input a scanning range of irradiation light. In this case, the processing circuit 60 obtains information on the scanning range from the input UI 50a.

### (Step S102)

The processing circuit 60 causes the adjuster of the support 20 to change the height and/or the orientation of the optical head 22 so that irradiation light output from the optical head 22 can be incident on the surface 10s of the object 10 at one angle of incidence selected from the multiple angles of incidence obtained in step S101.

### (Step S103)

The processing circuit 60 causes the range-finding device 30 to measure the distance of each of multiple measurement points included in the range-finding region 12 by using irradiation light which is output from the optical head 22 while being scanned. Alternatively, if the irradiation light has a wide irradiation range, the processing circuit 60 may cause the range-finding device 30 to measure the distances of multiple measurement points at one time by using the irradiation light output from the optical head 22 without being scanned.

### (Step S104)

The processing circuit 60 calculates a point cloud, which is the coordinates of multiple measurement points, from the angle of incidence of irradiation light incident on the measurement points and from the distances of the measurement points. The processing circuit 60 then stores data indicating the calculated point cloud, that is, point cloud data, in the storage 40.

### (Step S105)

The processing circuit 60 extracts an evaluation region 14 from the range-finding region 12, based on the point cloud data. For example, the evaluation region 14 may the central area of the range-finding region 12. The processing circuit 60 may extract the evaluation region 14 from any area of the range-finding region 12. As discussed above, the size of the evaluation region 14 may be determined in accordance with the dimensions of projecting portions or recessed portions of the uneven shape of the surface 10s in the X direction, Y direction, and Z direction, for example.

If the range-finding region 12 is narrow enough to match the evaluation region 14, the processing circuit 60 may skip step S105.

### (Step S106)

The processing circuit 60 calculates a roughness parameter in the evaluation region 14.

### (Step S107)

The processing circuit 60 determines whether it has examined all the angles of incidence. If the determination result is YES, the processing circuit 60 executes step S108. If the determination result is NO, the processing circuit 60 re-executes steps S102 through S106. In step S102, the processing circuit 60 causes the adjuster of the support 20 to change the height and/or the orientation of the optical head 22 so that the above-described irradiation light output from the optical head 22 can be incident on the surface 10s of the object 10 at another angle of the multiple angles of incidence. In this manner, the processing circuit 60 repeatedly executes steps S102 through S106.

### (Step S108)

The processing circuit 60 generates correction data and stores it in the storage 40.

### [Roughness Parameter Measurement Processing]

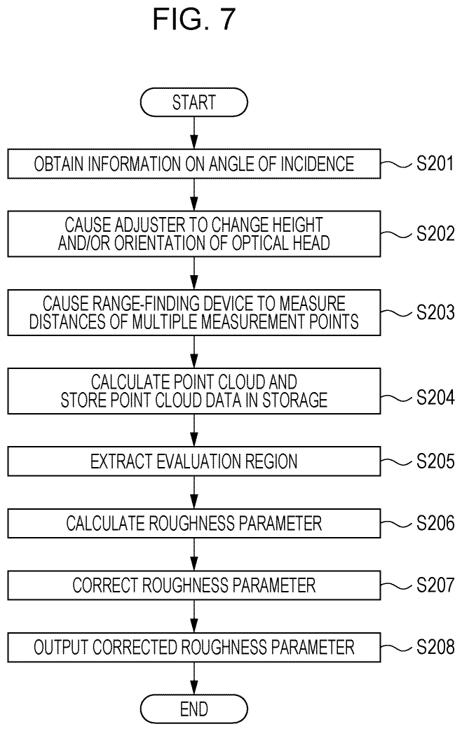

An example of roughness parameter measurement processing executed by the processing circuit 60 in the first embodiment will now be discussed below with reference to FIG. 7. FIG. 7 is a flowchart schematically illustrating an example of roughness parameter measurement processing executed by the processing circuit 60 in the first embodiment. The processing circuit 60 executes steps S201 through S208 in FIG. 7.

### (Step S201)

A user inputs the angle of incidence used for measurement via the input UI 50a shown in FIG. 3. The processing circuit 60 obtains information on the angle of incidence from the input UI 50a.

### (Steps S202 Through S206)

Steps S202 through S206 are the same as steps S102 through S106, respectively, in FIG. 6.

In step S202, the processing circuit 60 causes the adjuster of the support 20 to change the height and/or the orientation of the optical head 22 so that the above-described irradiation light output from the optical head 22 can be incident on the surface 10s of the object 10 at the angle of incidence input by the user as described above.

### (Step S207)

The processing circuit 60 obtains the correction data from the storage 40 and, based on the correction data, it corrects the roughness parameter in accordance with the angle of incidence of the irradiation light incident on the evaluation region 14. More specifically, the processing circuit 60 determines a correction parameter discussed with reference to FIGS. 5B and 5C, based on the angle of incidence of the irradiation light incident on the evaluation region 14 and the correction data, and corrects the roughness parameter based on the correction parameter. If the angle of incidence of the irradiation light incident on the evaluation region 14 is larger than the reference angle, the processing circuit 60 sets a greater correction amount for the roughness parameter as the angle of incidence of the irradiation light is larger. If the angle of incidence of the irradiation light incident on the evaluation region 14 is smaller than the reference angle, the processing circuit 60 sets a greater correction amount for the roughness parameter as the angle of incidence of the irradiation light is smaller.

### (Step S208)

The processing circuit 60 outputs the corrected roughness parameter and displays it on the display UI 50b.

Alternatively, the processing circuit 60 also outputs the roughness parameter which has not yet been corrected, as well as the corrected roughness parameter, and displays both of the roughness parameters on the display UI 50b. The two roughness parameters may be output and displayed at the same time or at different timings. The two roughness parameters may be output and displayed so as to be switched from each other.

If the relative error between the corrected roughness parameter and the reference value of an estimated roughness parameter is within an allowance range, it can be seen that no abnormality is occurring in the evaluation region 14. The allowance range is 5% or lower, for example. If the relative error exceeds the allowance range, it can be seen that an abnormality is occurring in the evaluation region 14. In this case, the processing circuit 60 displays a message on the display UI 50b to inform the user of the occurrence of an abnormality in the evaluation region 14.

If it is desirable that the surface 10s of the object 10 be rough, the processing circuit 60 may determine whether the corrected roughness parameter exceeds the reference value of the estimated roughness parameter and display the determination result on the display UI 50b. If it is desirable that the surface 10s of the object 10 be flat, the processing circuit 60 may determine whether the corrected roughness parameter is smaller than or equal to the reference value of the estimated roughness parameter and display the determination result on the display UI 50b. If the determination result is YES, it may be displayed as “OK”, and if the determination result is NO, it may be displayed as “No Good”.

As described above, the first embodiment makes it possible to implement the measurement system 100 and the measurement method that can measure the uneven shape of the evaluation region 14 more precisely. For a large object 10, there may be a case in which it is difficult to bring the support 20 close to the evaluation region 14, which makes it difficult to apply irradiation light to the evaluation region 14 substantially vertically. The measurement system 100 and the measurement method of the first embodiment can effectively be applied to such a case.

### Second Embodiment

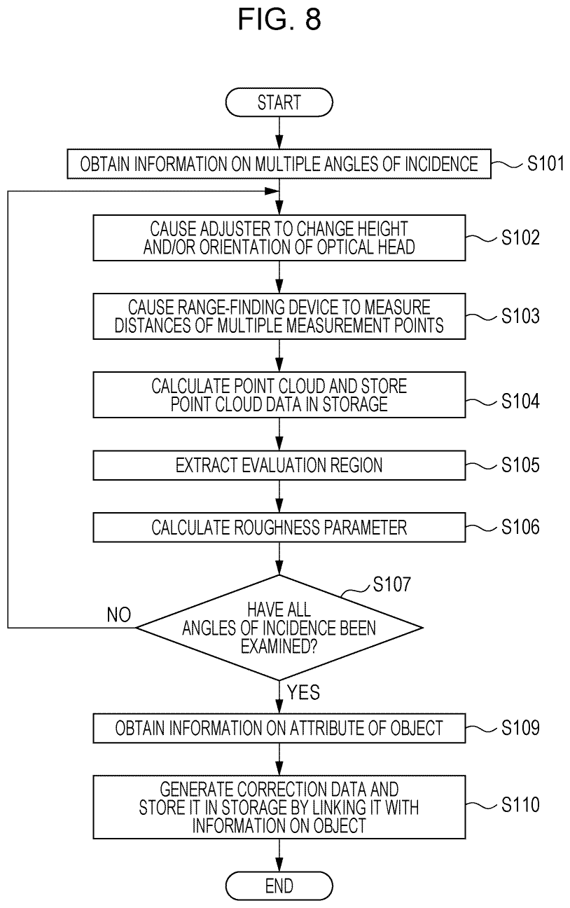

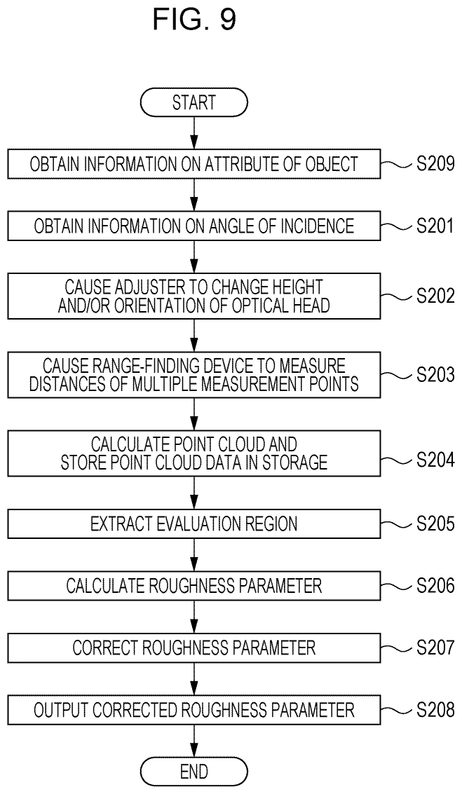

A measurement method according to a second embodiment of the disclosure will be described below with reference to FIGS. 8 and 9. In the measurement method of the second embodiment, the roughness parameter is corrected based on correction data reflecting an attribute of an object 10. The attribute of the object 10 may be at least one of the material, proportion of the material, size, polishing method for the surface 10s, or product number of the object 10, for example.

FIG. 8 is a flowchart schematically illustrating an example of correction data generating processing executed by the processing circuit 60 in the second embodiment. The processing circuit 60 executes steps S101 through S107, S109, and S110 in FIG. 8. Steps S101 through S107 in FIG. 8 are the same as steps S101 through S107, respectively, shown in FIG. 6. The processing circuit 60 executes step S109 after step S107.

### (Step S109)

A user inputs an attribute of the object 10 via the input UI 50a. The processing circuit 60 obtains information on the attribute of the object 10 from the input UI 50a.

### (Step S110)

The processing circuit 60 generates correction data and stores it in the storage 40 by linking it with the attribute of the object 10.

Instead of after step S107, the processing circuit 60 may execute step S109 before or after step S101.

As a result of the processing circuit 60 executing the above-described processing, correction data reflecting the attribute of the object 10 can be generated. The processing circuit 60 repeatedly executes the above-described processing for plural objects having different attributes, so that correction data can be stored in the storage 40 by object attribute.

An example of roughness parameter measurement processing executed by the processing circuit 60 in the second embodiment will now be discussed below with reference to FIG. 9. FIG. 9 is a flowchart schematically illustrating an example of roughness parameter measurement processing executed by the processing circuit 60 in the second embodiment. The processing circuit 60 executes steps S201 through S209 in FIG. 9. Steps S201 through S208 in FIG. 9 are the same as steps S201 through S208, respectively, in FIG. 7. The processing circuit 60 executes step S209 before step S201.

### (Step S209)

The user inputs the attribute of the object 10 to be measured via the input UI 50a. The processing circuit 60 obtains information on the attribute of the object 10 from the input UI 50a.

Instead of before step S201, the processing circuit 60 may execute step S209 after any one of steps S201 through S206 and before step S207.

In step S207, the processing circuit 60 obtains the correction data linked with the attribute of the object 10 among plural items of correction data stored in the storage 40. Based on the obtained correction data, the processing circuit 60 corrects the roughness parameter in accordance with the angle of incidence of the irradiation light incident on the evaluation region 14.

As is seen from the foregoing description, in addition to obtaining the advantages of the first embodiment, the second embodiment can implement the measurement system 100 and the measurement method that can correct the roughness parameter based on correction data linked with the attribute of the object 10.

### Third Embodiment

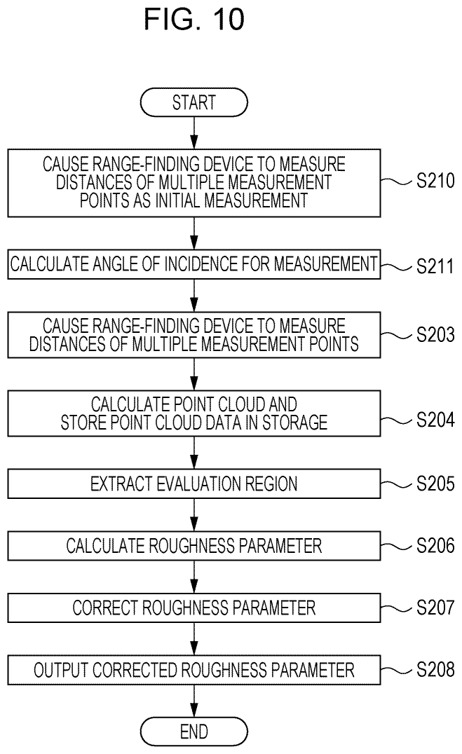

A measurement method according to a third embodiment of the disclosure will be described below with reference to FIG. 10. In the measurement method of the third embodiment, the angle of incidence of irradiation light is calculated when the angle between the surface 10s of the object 10 and the reference surface is unknown. The reference surface may be a flat surface, for example, or a surface perpendicular to a flat surface. The angle of incidence of irradiation light is the angle between the optical axis of the irradiation light and a line normal to the surface 10s of the object 10. If the angle between the surface 10s of the object 10 and the reference surface is known, the angle of incidence of irradiation light can be calculated. Correction data generating processing in the third embodiment is the same as that discussed in the first embodiment.

FIG. 10 is a flowchart schematically illustrating an example of roughness parameter measurement processing executed by the processing circuit 60 in the third embodiment. The processing circuit 60 executes steps S203 through S208, S210, and S211 in FIG. 10. Steps S203 through S208 in FIG. 10 are the same as steps S203 through S208, respectively, in FIG. 7. The processing circuit 60 executes steps S210 and S211 before step S203.

### (Step S210)

As initial measurement, the processing circuit 60 causes the range-finding device 30 to measure the distances of multiple measurement points in a state in which the optical head 22 is facing in a certain direction. Step S210 is the same as step S103 in FIG. 6. From the distance measurement results, the angle between the surface 10s of the object 10 and the reference surface can be identified.

### (Step S211)

The processing circuit 60 calculates the angle of incidence of irradiation light, based on the distance measurement results in step S210.

As is seen from the foregoing description, in addition to obtaining the advantages of the first embodiment, the third embodiment can implement the measurement system 100 and the measurement method that can calculate the angle of incidence for measurement before irradiation light is emitted. This can save a user inputting the angle of incidence for measurement and also reduce input errors which may be made by the user.

### Fourth Embodiment

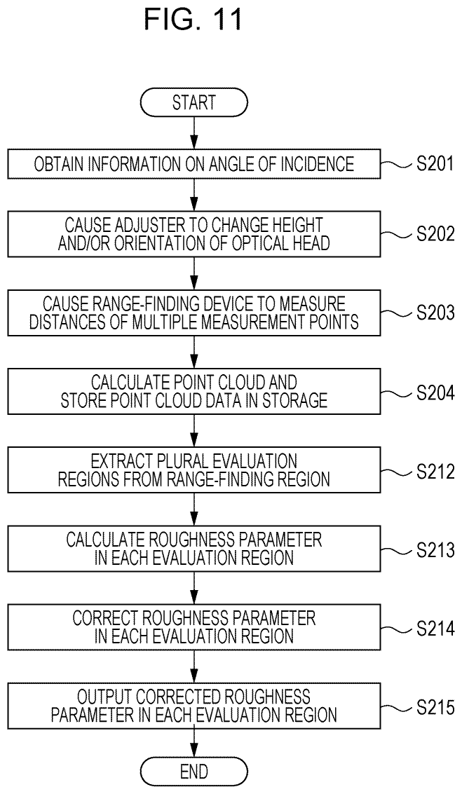

A measurement method according to a fourth embodiment of the disclosure will be described below with reference to FIG. 11. In the measurement method of the fourth embodiment, plural evaluation regions are extracted from the range-finding region 12 and a roughness parameter in each evaluation region is measured. The plural evaluation regions may be obtained by dividing the range-finding region 12 into M-row N-column matrices, for example. M and N are natural numbers and the product of M and N is two or more. Correction data generating processing in the fourth embodiment is the same as that discussed in the first embodiment.

FIG. 11 is a flowchart schematically illustrating an example of roughness parameter measurement processing executed by the processing circuit 60 in the fourth embodiment. The processing circuit 60 executes steps S201 through S204 and S212 through S215 in FIG. 11. Steps S201 through S204 in FIG. 11 are the same as steps S201 through S204, respectively, in FIG. 7. The processing circuit 60 executes step S212 after step S204.

### (Step S212)

The processing circuit 60 extracts plural evaluation regions 14 from the range-finding region 12.

### (Step S213)

The processing circuit 60 calculates a roughness parameter in each evaluation region 14.

### (Step S214)

The processing circuit 60 obtains correction data from the storage 40 and, based on the obtained correction data, it corrects the roughness parameter in each evaluation region in accordance with the angle of incidence of the irradiation light incident on the corresponding evaluation region 14. The reference angle for correction may be the angle of incidence of the irradiation light incident on one of the plural evaluation regions 14 or may be a preset angle.

### (Step S215)

The processing circuit 60 outputs the corrected roughness parameter in each evaluation region 14 and displays it on the display UI 50b.

Alternatively, the processing circuit 60 also outputs the roughness parameter in each evaluation region 14 which has not yet been corrected, as well as the corrected roughness parameter in each evaluation region 14, and displays both of the roughness parameters on the display UI 50b. The two roughness parameters may be output and displayed at the same time or at different timings. The two roughness parameters may be output and displayed so as to be switched from each other.

As is seen from the foregoing description, in addition to obtaining the advantages of the first embodiment, the fourth embodiment can implement the measurement system 100 and the measurement method that can extract plural evaluation regions from the range-finding region 12 and measure the roughness parameter in each evaluation region. This makes it possible to measure roughness parameters in plural evaluation regions more precisely even when the angles of incidence of irradiation light in the plural evaluation regions are different from each other. The roughness parameters in the plural evaluation regions can also be easily compared with each other.

### Fifth Embodiment

The roughness parameter calculated from the measurement results is the sum of the actual roughness parameter and noise due to the measurement error. For example, the root mean square height S_{qmeasure} calculated from the measurement results is represented by the following expression (4):

$${S}_{qmeasure} = \sqrt{{S}_{qobj}^{2} + {S}_{error}^{2}} \qquad ( 4 )$$

where S_{qobj} is the root mean square height of the uneven shape of the object 10, and S_{qerror} is the root mean square height of the uneven shape resulting from the measurement error.

According to expression (4), as the measurement error is greater, the roughness parameter calculated from the measurement results becomes greater. As the measurement distance is longer, the measurement error becomes greater. The roughness parameter calculated from the measurement results thus becomes greater as the measurement distance becomes longer.

If the correlation between the measurement distance and the measurement error is known, the roughness parameter calculated from the measurement results can be corrected in accordance with the measurement distance, based on expression (4). As a result, the roughness parameter can be measured precisely.

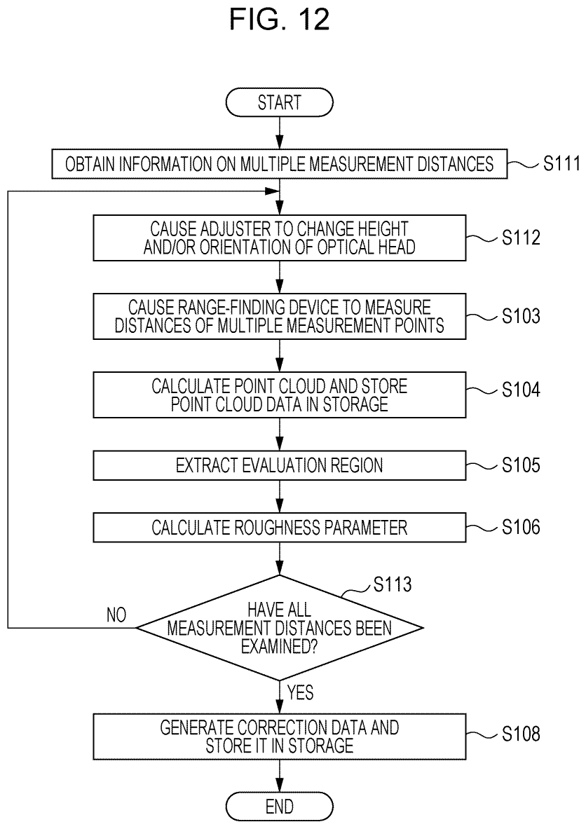

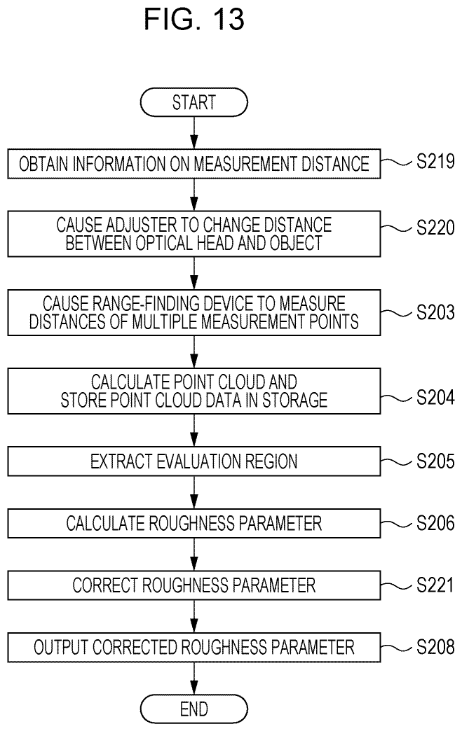

A measurement method according to a fifth embodiment of the disclosure will be described below with reference to FIGS. 12 and 13. In the measurement method of the fifth embodiment, the roughness parameter is corrected based on the measurement distance. FIG. 12 is a flowchart schematically illustrating an example of correction data generating processing executed by the processing circuit 60 in the fifth embodiment. The processing circuit 60 executes steps S103 through 106, S108, and S111 through S113 in FIG. 12. Steps S103 through S106 and S108 in FIG. 12 are the same as steps S103 through S106 and S108, respectively, in FIG. 6. The processing circuit 60 executes steps S111 and S112 before step S103 and executes step S113 after step S106.

### (Step S111)

A user inputs multiple measurement distances used for correction data via the input UI 50a shown in FIG. 3. The processing circuit 60 obtains information on the multiple measurement distances from the input UI 50a. The multiple measurement distances may be set by changing the distance from a first measurement distance to a second measurement distance in increments of a certain value of distance, for example. The first measurement distance may be 0.5 m, for example. The second measurement distance may be the distance of irradiation light that can illuminate a peripheral area of the surface 10a of the object 10, for example. The measurement distance may be varied in increments of 0.5 m or 1 m, for example.

The user may also input a scanning range of irradiation light. In this case, the processing circuit 60 obtains information on the scanning range from the input UI 50a.

### (Step S112)

The processing circuit 60 causes the adjuster of the support 20 to change the height and/or the orientation of the optical head 22 so that the distance between the optical head 22 and the surface 10s of the object 10 can be one measurement distance selected from the above-described multiple measurement distances.

The distance between the optical head 22 and the surface 10s of the object 10 is determined by the height and/or the orientation of the optical head 22. To vary this distance, the processing circuit 60 may cause the adjuster of the support 20 to change only one of or both of the height and the orientation of the optical head 22.

### (Step S113)

The processing circuit 60 determines whether it has examined all the measurement distances. If the determination result is YES, the processing circuit 60 executes step S108. If the determination result is NO, the processing circuit 60 re-executes steps S112 and S103 through S106 in this order. In step S112, the processing circuit 60 causes the adjuster of the support 20 to change the height and/or the orientation of the optical head 22 so that the distance between the optical head 22 and the surface 10s of the object 10 becomes another one of the above-described measurement distances. In this manner, the processing circuit 60 repeatedly executes steps S112 and S103 through S106.

With the above-described processing of the processing circuit 60, correction data can be generated in accordance with the measurement distance. This correction data can be data indicating the correlation between the measurement distance and the measurement error. If the roughness parameter without measurement error is known, the correlation between the measurement distance and the measurement error can be determined from the roughness parameter calculated from the measurement results and expression (4).

An example of roughness parameter measurement processing executed by the processing circuit 60 according to the fifth embodiment will now be explained below with reference to FIG. 13. FIG. 13 is a flowchart schematically illustrating an example of roughness parameter measurement processing executed by the processing circuit 60 in the fifth embodiment. The processing circuit 60 executes steps S203 through S206, S208, and S219 through S221 in FIG. 13. Steps S203 through S206 and S208 in FIG. 13 are the same as steps S203 through S206 and S208, respectively, in FIG. 7. The processing circuit 60 executes steps S219 and S220 before step S203 and executes step S221 after step S206.

### (Step S219)

A user inputs a measurement distance used for measurement via the input UI 50a shown in FIG. 3. The processing circuit 60 obtains information on the measurement distance from the input UI 50a.

### (Step S220)

Step S220 is the same as step S112 in FIG. 12.

### (Step S221)

The processing circuit 60 obtains correction data from the storage 40 and, based on the correction data, it corrects the roughness parameter in accordance with the measurement distance in the evaluation region 14. The processing circuit 60 may correct the roughness parameter by using expression (4), for example.

The measurement distance in the evaluation region 14 may be the distance from the center of the light exit plane of the optical head 22 to the center of the evaluation region 14, for example. Alternatively, the measurement distance in the evaluation region 14 may be the longest or the shortest measurement distance from the center of the light exit plane of the optical head 22 to the evaluation region 14, for example.

The measurement distance from which the roughness parameter can be calculated most precisely is set to the reference distance for correction. As the measurement distance is longer, the measurement error becomes larger. From this point of view, when the measurement distance is almost zero, the roughness parameter can be calculated most precisely. Depending on the settings of a lens in the range-finding device 30, however, the roughness parameter may be calculated most precisely when the measurement distance is not zero.

If the measurement distance in the evaluation region 14 is larger than the reference distance, the processing circuit 60 sets a greater correction amount for the roughness parameter as the measurement distance is longer. If the measurement distance in the evaluation region 14 is smaller than the reference distance, the processing circuit 60 sets a greater correction amount for the roughness parameter as the measurement distance is shorter.

As is seen from the foregoing description, according to the fifth embodiment, as a result of correcting the roughness parameter in accordance with the measurement distance in the evaluation region 14, the degree of the surface unevenness in the evaluation region 14 can be evaluated more precisely.

### Sixth Embodiment

As discussed above, according to expression (4), as the measurement error is greater, the roughness parameter calculated from the measurement results becomes larger. When the intensity of received light is lowered, the measurement error is increased. The roughness parameter calculated from the measurement results thus becomes larger as the intensity of received light becomes lower.

If the correlation between the intensity of received light and the measurement error is known, the roughness parameter calculated from the measurement results can be corrected in accordance with the intensity of received light, based on expression (4). As a result, the roughness parameter can be measured precisely.

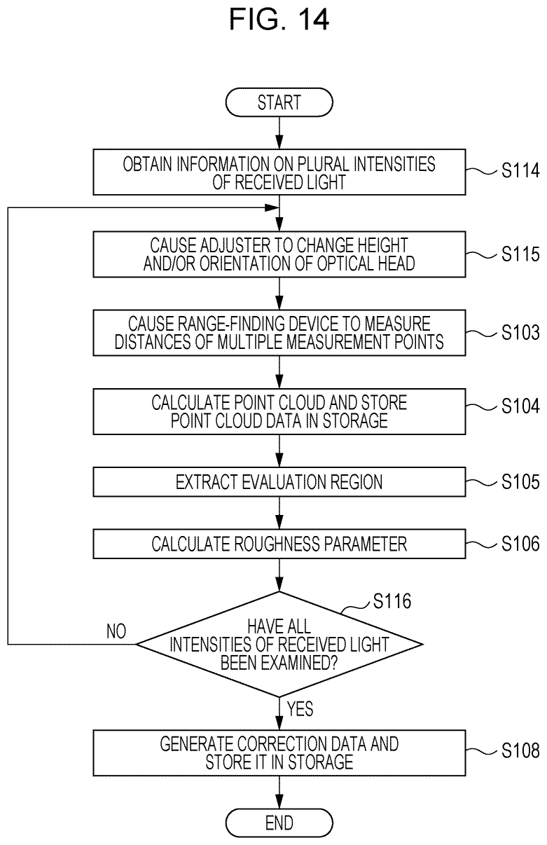

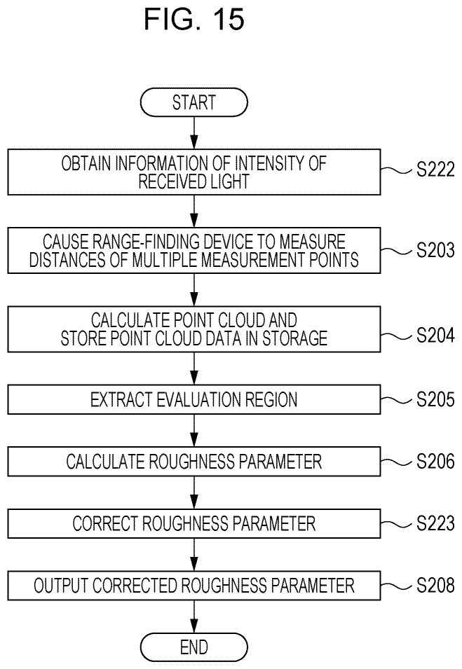

A measurement method according to a sixth embodiment of the disclosure will be described below with reference to FIGS. 14 and 15. In the measurement method of the sixth embodiment, the roughness parameter is corrected based on the intensity of received light. FIG. 14 is a flowchart schematically illustrating an example of correction data generating processing executed by the processing circuit 60 in the sixth embodiment. The processing circuit 60 executes steps S103 through 106, S108, and S114 through S116 in FIG. 14. Steps S103 through S106 and S108 in FIG. 14 are the same as steps S103 through S106 and S108, respectively, in FIG. 6. The processing circuit 60 executes steps S114 and S115 before step S103 and executes step S116 after step S106.

### (Step S114)

A user inputs plural intensities of received light used for correction data via the input UI 50a. The processing circuit 60 obtains information on the plural intensities of received light from the input UI 50a. The plural intensities of received light can be set by varying the intensity of received light from a first intensity to a second intensity in increments of a certain value of the intensity.

### (Step S115)

The processing circuit 60 causes the adjuster of the support 20 to change the height and/or the orientation of the optical head 22 so that the intensity of light which is output from the optical head 22 and which is scattered and/or reflected on the surface 10s of the object 10 becomes the intensity selected from the above-described plural intensities of received light.

The intensity of light scattered and/or reflected on the surface 10s of the object 10 is determined by the height and/or the orientation of the optical head 22, for example. The reflectance and/or the diffusion rate of the surface 10s of the object 10 with respect to irradiation light may be different in accordance with the positional relationship between the optical head 22 and the surface 10s of the object 10. To vary the intensity of received light, the processing circuit 60 may cause the adjuster of the support 20 to change only one of or both of the height and the orientation of the optical head 22.

To vary the intensity of received light by changing the reflectance and/or the diffusion rate, the object 10 itself may be changed. In this case, the user may change the object 10.

### (Step S116)

The processing circuit 60 determines whether it has examined all the intensities of received light. If the determination result is YES, the processing circuit 60 executes step S108. If the determination result is NO, the processing circuit 60 re-executes steps S115 and S103 through S106 in this order. In step S115, the processing circuit 60 causes the adjuster of the support 20 to change the height and/or the orientation of the optical head 22 so that the intensity of light scattered and/or reflected on the surface 10s of the object 10 becomes another one of the above-described intensities. In this manner, the processing circuit 60 repeatedly executes steps S115 and S103 through S106.

With the above-described processing of the processing circuit 60, correction data can be generated in accordance with the intensity of received light. This correction data can be data indicating the correlation between the intensity of received light and the measurement error. If the roughness parameter without any measurement error is known, the correlation between the intensity of received light and the measurement error can be determined from the roughness parameter calculated from the measurement results and expression (4).

An example of roughness parameter measurement processing executed by the processing circuit 60 according to the sixth embodiment will now be described below with reference to FIG. 15. FIG. 15 is a flowchart schematically illustrating an example of roughness parameter measurement processing executed by the processing circuit 60 in the sixth embodiment. The processing circuit 60 executes steps S203 through S206, S208, S222, and S223 in FIG. 15. Steps S203 through S206 and S208 in FIG. 15 are the same as steps S203 through S206 and S208, respectively, in FIG. 7. The processing circuit 60 executes step S222 before step S203 and executes step S223 after step S206.

### (Step S222)

A user inputs the intensity of received light used for measurement via the input UI 50a shown in FIG. 3. The processing circuit 60 obtains information on the intensity of received light from the input UI 50a.

### (Step S223)

The processing circuit 60 obtains correction data from the storage 40 and, based on the correction data, it corrects the roughness parameter in accordance with the intensity of received light obtained as a result of the evaluation region 14 being irradiated with irradiation light. The processing circuit 60 may correct the roughness parameter by using expression (4), for example.

The intensity of received light obtained as a result of the evaluation region 14 being irradiated with irradiation light may be the average intensity of plural intensities of received light obtained as a result of multiple measurement points in the evaluation region 14 being irradiated with irradiation light, for example. Alternatively, the intensity of received light obtained as a result of the evaluation region 14 being irradiated with irradiation light may be the highest or the lowest intensity of these plural intensities of received light, for example.

The intensity of received light from which the roughness parameter can be calculated most precisely is set to the reference intensity for correction. As the intensity of received light is lower, the measurement error becomes larger. From this point of view, when the intensity of received light is sufficiently high to such a degree not to be saturated, the roughness parameter can be calculated most precisely. Depending on the settings of the optical detector in the range-finding device 30, however, the roughness parameter may be calculated most precisely when the intensity of received light is a certain finite value even if it is not sufficiently high.

If the intensity of received light in the evaluation region 14 is higher than the reference intensity, the processing circuit 60 sets a greater correction amount for the roughness parameter as the intensity of received light is higher. If the intensity of received light in the evaluation region 14 is lower than the reference intensity, the processing circuit 60 sets a greater correction amount for the roughness parameter as the intensity of received light is lower.

As is seen from the foregoing description, according to the sixth embodiment, as a result of correcting the roughness parameter in accordance with the intensity of received light obtained as a result of the evaluation region 14 being irradiated with irradiation light, the degree of the surface unevenness in the evaluation region 14 can be evaluated more precisely.

### Seventh Embodiment

In the roughness parameter measurement processing in the first embodiment, as illustrated in FIG. 7, the processing circuit 60 corrects the calculated roughness parameter in accordance with the angle of incidence of irradiation light incident on the evaluation region 14 in step S207, and then compares the corrected roughness parameter with the reference value in step S208. Unlike the first embodiment, the processing circuit 60 may correct the reference value instead of the calculated roughness parameter. In this case, too, the roughness parameter may be compared with the corrected reference value in accordance with the angle of incidence of irradiation light.

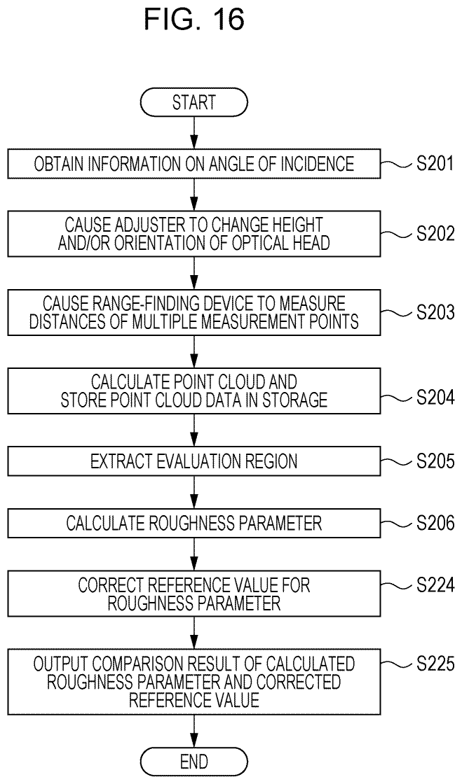

An example of roughness parameter measurement processing executed by the processing circuit 60 in a seventh embodiment will now be described below with reference to FIG. 16. Correction data generating processing in the seventh embodiment is the same as in the first embodiment.

FIG. 16 is a flowchart schematically illustrating an example of roughness parameter measurement processing executed by the processing circuit 60 in the seventh embodiment. The processing circuit 60 executes steps S201 through S206, S224, and S225 in FIG. 16. Steps S201 through S206 in FIG. 16 are the same as steps S201 through S206, respectively, in FIG. 7. The processing circuit 60 executes steps S224 and S225 after step S206.

### (Step S224)

The processing circuit 60 obtains correction data from the storage 40 and, based on the correction data, it corrects the reference value used for evaluating the calculated roughness parameter in accordance with the angle of incidence of irradiation light incident on the evaluation region 14. The reference value is the value as discussed in the first embodiment and can be corrected as discussed with reference to FIGS. 5A through 5C.

### (Step S225)

The processing circuit 60 outputs the comparison result of the calculated roughness parameter and the corrected reference value and displays the comparison result on the display UI 50b.

In the above-described example, the processing circuit 60 corrects the reference value in accordance with the angle of incidence of irradiation light incident on the evaluation region 14. However, this is only an example. The processing circuit 60 may correct the reference value in accordance with the measurement distance in the evaluation region 14 or the intensity of received light obtained as a result of the evaluation region 14 being irradiated with irradiation light.

As is seen from the foregoing description, according to the seventh embodiment, as a result of correcting the reference value while the calculated roughness parameter remaining the same, the degree of the surface unevenness in the evaluation region 14 can be evaluated more precisely.

### Eighth Embodiment

In the roughness parameter measurement processing in the third embodiment, the processing circuit 60 causes the range-finding device 30 to measure multiple measurement points as initial settings in step S210, as illustrated in FIG. 10. The processing circuit 60 may omit the initial settings and execute step S203.

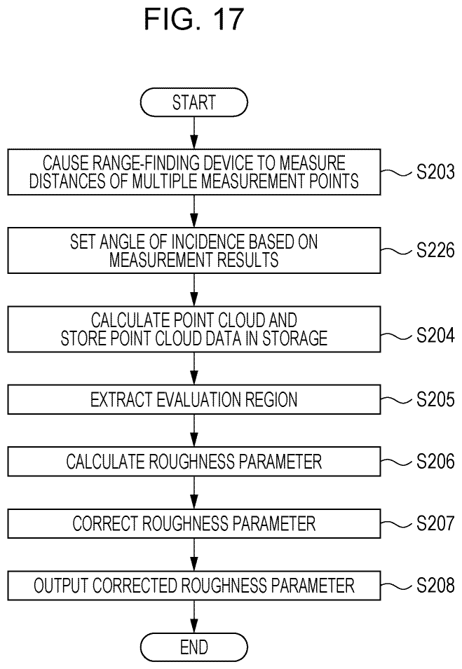

An example of roughness parameter measurement processing executed by the processing circuit 60 in an eighth embodiment will now be described below with reference to FIG. 17. Correction data generating processing in the eighth embodiment is the same as in the first embodiment.

FIG. 17 is a flowchart schematically illustrating an example of roughness parameter measurement processing executed by the processing circuit 60 in the eighth embodiment. The processing circuit 60 executes steps S203 through S208 and S226 in FIG. 17. Steps S203 through S208 in FIG. 17 are the same as steps S203 through S208, respectively, in FIG. 10. The processing circuit 60 executes step S226 after step S203.

### (Step S226)

The processing circuit 60 sets the angle of incidence of irradiation light incident on the evaluation region 14, based on the measurement results in step S203.

In this example, the processing circuit 60 sets the angle of incidence of irradiation light incident on the evaluation region 14 based on the measurement results and corrects the roughness parameter in accordance with this angle of incidence. However, this is only an example. The processing circuit 60 may set the measurement distance in the evaluation region 14 based on the measurement results and correct the roughness parameter in accordance with the measurement distance. Alternatively, based on the measurement results, the processing circuit 60 may set the intensity of received light obtained as a result of the evaluation region 14 being irradiated with irradiation light and correct the roughness parameter in accordance with the intensity of received light.

As is seen from the foregoing description, according to the eighth embodiment, the initial settings are omitted and the number of measurement times can be reduced. As a result, compared with the third embodiment, the degree of the surface unevenness in the evaluation region 14 can be evaluated in a shorter period of time.

The operations of the processing circuit 60 according to the first through eighth embodiments may be combined in a desired manner as long as the combination result does not have any inconsistencies. In one example, the correcting operation for the roughness parameter based on correction data linked with the attribute of the object 10 in the second embodiment may be applied to the third through eighth embodiments. In another example, the calculating operation for the angle of incidence of irradiation light in the third embodiment may be applied to the second, fourth, and seventh embodiments. In another example, the operation for extracting plural evaluation regions from the range-finding region 12 and measuring the roughness parameter in each evaluation region in the fourth embodiment may be applied to the second, third, and fifth through eighth embodiments.

### Ninth Embodiment

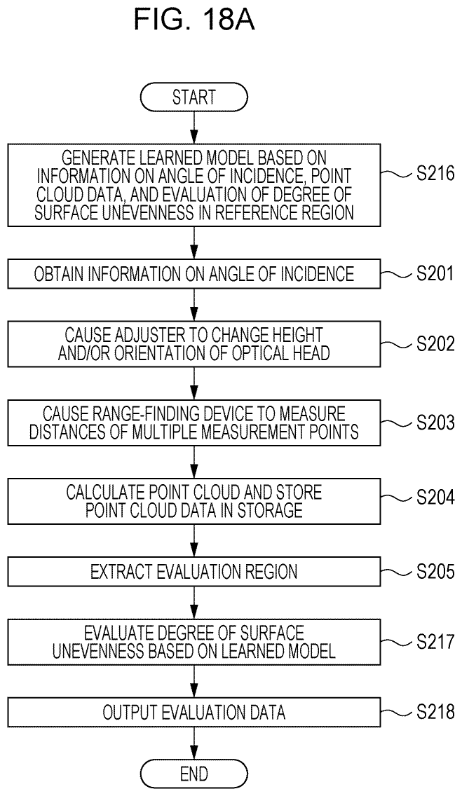

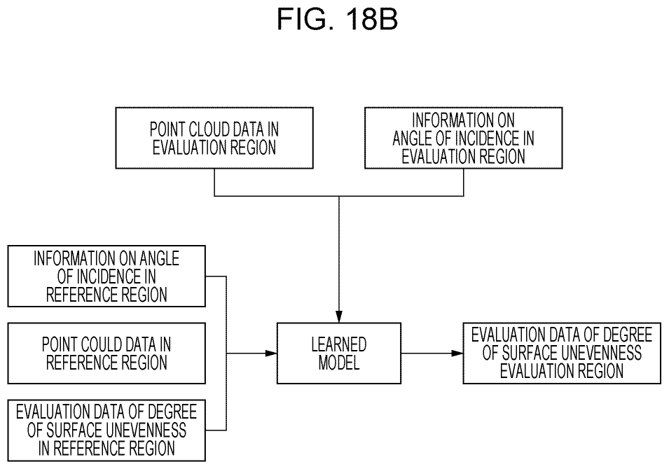

A measurement method according to a ninth embodiment of the disclosure will be described below with reference to FIGS. 18A and 18B. In the measurement method of the ninth embodiment, the degree of the surface unevenness of the object 10 is evaluated with a learned model. In the specification, “evaluating the degree of the surface unevenness” includes, not only the meaning that the uneven shape of the surface is evaluated by calculating the roughness parameter, but also the meaning that the uneven shape of the surface is directly evaluated without calculating the roughness parameter. An example of direct evaluation of the uneven shape of the surface is direct examination of the uneven shape of the surface, as in the example shown in FIG. 2A.

FIG. 18A is a flowchart schematically illustrating an example of evaluation processing for the surface unevenness degree executed by the processing circuit 60 in the ninth embodiment. FIG. 18B is a block diagram schematically illustrating an example of a flow of data which is input and generated in the evaluation processing for the surface unevenness degree. The processing circuit 60 executes steps S201 through S205 and S216 through S218 in FIG. 18A. Steps S201 through S205 in FIG. 18A are the same as steps S201 through S205, respectively, in FIG. 7. The processing circuit 60 executes step S216 before step S201 and executes steps S217 and S218 after step S205.

### (Step S216)

As illustrated in FIG. 18B, the processing circuit 60 generates a supervised learned model in which learning is conducted by using, as training data, information on the angle of incidence of irradiation light in a reference region, point cloud data in the reference region, and evaluation data indicating the degree of the surface unevenness of the uneven shape in the reference region. Point cloud data can be obtained from a detection signal of the optical detector, and the above-described point cloud data may thus be called a detection signal.

The reference region may be one of multiple different regions of the surface 10s of the object 10, for example. The multiple regions may be regions obtained by dividing one region of the surface 10s of the object 10 linearly or two-dimensionally or may be regions discretely distributed on the surface 10s of the object 10. Alternatively, the reference region may be one of multiple virtual regions corresponding to multiple angles of incidence, for example. Each of the virtual regions may have an uneven shape of a corresponding one of the assumed regions of the surface 10s of the object 10, for example.

To generate a learned model, information on the angle of incidence of irradiation light, point cloud data, and evaluation data in each of the above-described multiple regions or virtual regions are obtained. The learned model can be generated by utilizing a known machine learning algorithm, such as a neural network.

### (Step S217)

By using the learned model generated in step S216, the processing circuit 60 evaluates the degree of the surface unevenness in the evaluation region 14 from the point cloud data and information on the angle of incidence in the evaluation region 14, as shown in FIG. 18B.

### (Step S218)

The processing circuit 60 outputs evaluation data indicating the degree of the surface unevenness in the evaluation region 14, as shown in FIG. 18B.

As is seen from the foregoing description, according to the ninth embodiment, the degree of the surface unevenness in the evaluation region 14 can be evaluated more precisely by using a learned model.

### Configuration Example of Range-Finding Device 30

### [FMCW-LiDAR System]

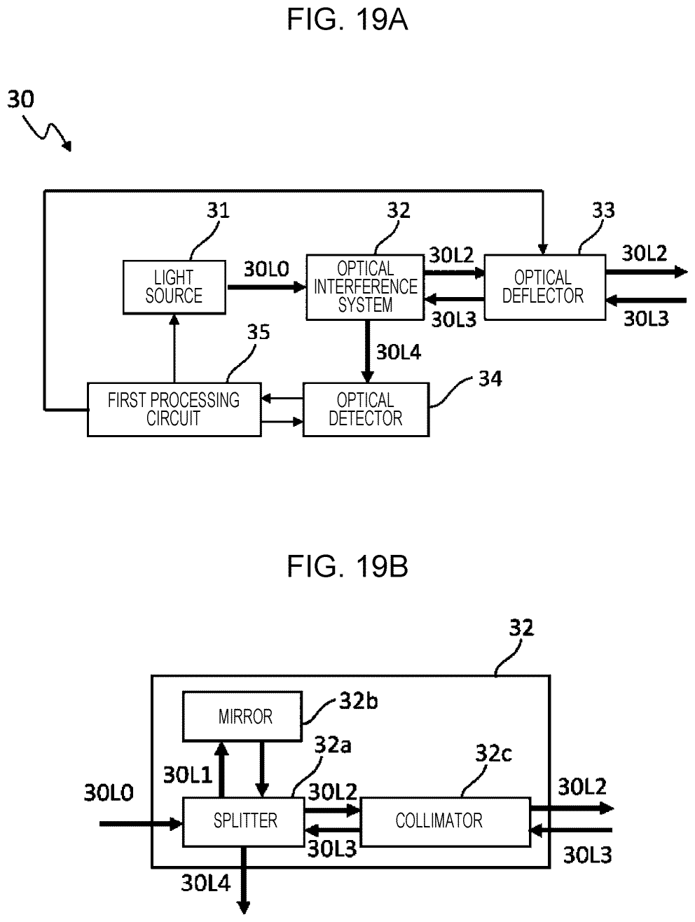

An example of the configuration of the range-finding device 30 using the FMCW-LiDAR system will be discussed below with reference to FIGS. 19A and 19B. FIG. 19A is a block diagram schematically illustrating an example of the configuration of the FMCW-LiDAR range-finding device 30. The range-finding device 30 shown in FIG. 19A includes a light source 31, an optical interference system 32, an optical deflector 33, an optical detector 34, a first processing circuit 35, and a memory, which is not shown. FIG. 19B is a block diagram schematically illustrating an example of the configuration of the optical interference system 32 shown in FIG. 19A. The thick arrows in FIGS. 19A and 19B indicate the flow of light.

The components of the range-finding device 30 and those of the optical interference system 32 will be explained below.

The light source 31 emits laser light 30L0. The light source 31 can change the frequency of laser light 30L0, for example, in the shape of a triangle wave or a sawtooth wave in a certain time period. The time period may be longer than or equal to 1μ second and shorter than or equal to 10 m seconds, for example. The time period may be variable. The frequency variation range may be greater than or equal to 100 MHz and smaller than or equal to 1 THz, for example. The wavelength of laser light 30L0 may be included in the wavelength range of visible light or that of ultraviolet light or infrared light.

The light source 31 may include a distributed feedback (DFB) laser diode or an external cavity (EC) laser diode. These types of laser diodes are small and inexpensive and can perform single-mode oscillation and modulate the frequency of laser light 30L0 in accordance with the amount of current to be applied.

As illustrated in FIG. 19B, the optical interference system 32 includes a splitter 32a, a mirror 32b, and a collimator 32c. The splitter 32a splits laser light 30L0 emitted from the light source 31 into reference light 30L1, which is part of laser light 30L0, and irradiation light 30L2, which is the remaining light of laser light 30L0. The ratio of the intensity of reference light 30L1 to laser light 30L0 is higher than or equal to 1% and lower than or equal to 20%, for example. Since laser light 30L0 includes reference light 30L1 and irradiation light 30L2, it can be said that the light source 31 emits irradiation light 30L2 to be applied to multiple measurement points included in the evaluation region 14. The mirror 32b reflects reference light 30L1 and returns it to the splitter 32a. The collimator 32c collimates irradiation light 30L2 and outputs collimated irradiation light 30L2. In the specification, “collimating” or “to collimate” includes, not only the meaning that irradiation light 30L2 is formed into perfect parallel light, but also the meaning that irradiation light 30L2 is narrowed down. Reflected light 30L3 returned from multiple measurement points included in the evaluation region 14 is incident on the splitter 32a via the optical deflector 33 and the collimator 32c. The splitter 32a outputs interference light 30LA generated as a result of reference light 30L1 and reflected light 30L3 interfering with each other.

The optical deflector 33 changes the direction of irradiation light 30L2. The angle of incidence of irradiation light 30L2 incident on the surface 10s of the object 10 is determined by the direction of irradiation light 30L2. The optical deflector 33 may be one of the following elements: a galvanometer scanner, a polygon mirror, a micro electromechanical system (MEMS) scanner, a phase modulation scanner, a refractive-index modulation scanner, and a wavelength modulation scanner.

The optical detector 34 detects interference light 30L4 and outputs a detection signal indicating the intensity of interference light 30L4. Since interference light 30L4 includes reference light 30L1 and reflected light 30L3, it can be said that the optical detector 34 receives reflected light 30L3. The optical detector 34 includes at least one optical detection element.

In the range-finding device 30, the path in which irradiation light 30L2 is output from the optical interference system 32 and reaches the surface 10s of the object 10 matches the path in which reflected light 30L3 is output from the surface 10s of the object 10 and returns to the optical interference system 32. Using such a coaxial optical system can simplify the configuration of the range-finding device 30 and implement stable distance measurement.

The first processing circuit 35 controls the operations of the light source 31, optical deflector 33, and optical detector 34 so as to process a detection signal output from the optical detector 34. The first processing circuit 35 causes the light source 31 to emit irradiation light 30L2 to be applied to multiple measurement points included in the evaluation region 14 and causes the optical detector 34 to receive reflected light 30L3 returned from these measurement points and to output a detection signal. Based on this detection signal, the first processing circuit 35 generates and outputs distance information of each of the measurement points included in the evaluation region 14. More specifically, the first processing circuit 35 performs Fourier transform on the time waveform of the detection signal to generate information on the beat frequency of interference light 30L4. Then, the first processing circuit 35 generates and outputs distance information, based on the information on the beat frequency. A computer program executed by the processing circuit 60 is stored in the memory, which is not shown. This memory is similar to the memory 62 shown in FIG. 3.

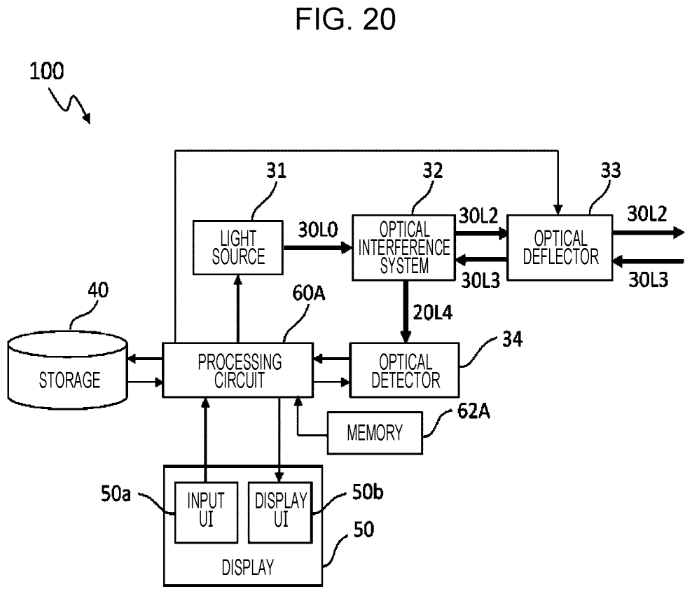

The first processing circuit 35 shown in FIG. 19A and the processing circuit 60, which is the second processing circuit, shown in FIG. 3 may be integrated with each other. An example of the configuration in which the first processing circuit 35 and the processing circuit 60 are integrated with each other will be discussed below with reference to FIG. 20. FIG. 20 is a block diagram schematically illustrating an example of the configuration of an FMCW-LiDAR measurement system 100 including an integrated processing circuit 60A. For simple representation, the support 20 illustrated in FIG. 3 is not shown in FIG. 20. The integrated processing circuit 60A in FIG. 20 includes the first processing circuit 35 shown in FIG. 19A and the processing circuit 60 shown in FIG. 3. A computer program executed by the integrated processing circuit 60A is stored in a memory 62A. The memory 62A is similar to the memory 62 shown in FIG. 3.

### [TOF System]

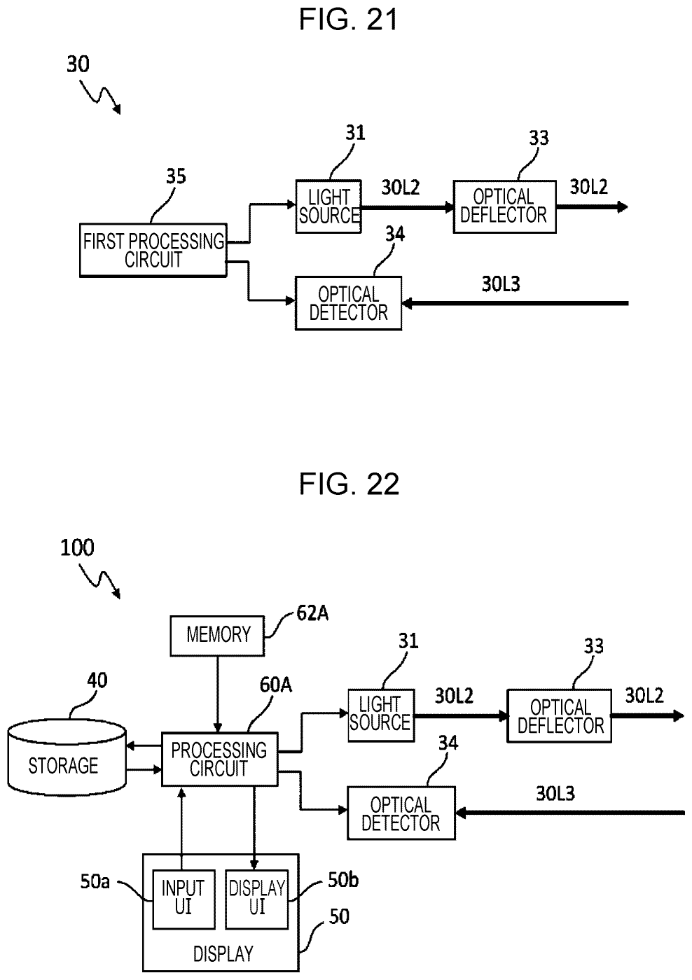

An example of the configuration of the range-finding device 30 of the TOF system will now be described below with reference to FIG. 21. FIG. 21 is a block diagram schematically illustrating an example of the configuration of the TOF range-finding device 30. The range-finding device 30 shown in FIG. 21 includes a light source 31, an optical deflector 33, an optical detector 34, a first processing circuit 35, and a memory, which is not shown.

The light source 31 emits irradiation light 30L2 to be applied to multiple measurement points included in the evaluation region 14 via the optical deflector 33. Irradiation light 30L2 may be laser light or LED light. The light source 31 may include a laser diode or an LED, for example.

The optical deflector 33 is as discussed with reference to FIG. 19A. If irradiation light 30L2 has a sufficiently wide irradiation range to measure the distances of multiple measurement points included in the evaluation range 14 at one time, the provision of the optical deflector 33 for the range-finding device 30 may be omitted.

The optical detector 34 includes at least one optical detection element and receives reflected light 30L3. In the direct TOF system, the time from which irradiation light 30L2 is emitted until when it is returned as reflected light 30L3 indicates distance information on a measurement point. If the range-finding device 30 utilizes the indirect TOF system, the optical detector 34 detects reflected light 30L3 in a first period for which irradiation light 30L2, which is pulse light, is emitted, and outputs a first detection signal indicating the intensity of reflected light 30L3. The optical detector 34 also detects reflected light 30L3 in a second period, which is followed by the first period and has the same time duration as the first period, and outputs a second detection signal indicating the intensity of reflected light 30L3. The intensity of the second detection signal to the total intensity of the first and second detection signals indicates distance information on a measurement point.

If the optical detector 34 is an image sensor including two-dimensionally arranged plural optical detection elements, the optical detection elements correspond to the respective measurement points. A detection signal output from each optical detection element indicates distance information of the corresponding measurement point. In this case, as a result of having multiple measurement points irradiated with irradiation light 30L2 having a wide irradiation range, reflected light 30L3 is detected from the measurement points at one time. If the measurement points are individually irradiated with irradiation light 30L2 while scanning irradiation light 30L2, the optical detector 34 may have a single optical detection element.

The first processing circuit 35 controls the operations of the light source 31 and the optical detector 34 and processes a detection signal output from the optical detector 34. The first processing circuit 35 causes the light source 31 to emit irradiation light 30L2 to be applied to the evaluation region 14 and the optical detector 34 to receive reflected light 30L3, to detect the received reflected light 30L3 for a certain period, and to output a detection signal. Based on this detection signal, the first processing circuit 35 generates and outputs distance information of each of the multiple measurement points included in the evaluation region 14.

The first processing circuit 35 shown in FIG. 21 and the processing circuit 60, which is the second processing circuit, shown in FIG. 3 may be integrated with each other. An example of the configuration in which the first processing circuit 35 and the processing circuit 60 are integrated with each other will be discussed below with reference to FIG. 22. FIG. 22 is a block diagram schematically illustrating an example of the configuration of a TOF measurement system 100 including an integrated processing circuit 60A. For simple representation, the support 20 illustrated in FIG. 3 is not shown in FIG. 22. The integrated processing circuit 60A in FIG. 22 includes the first processing circuit 35 shown in FIG. 21 and the processing circuit 60 shown in FIG. 3. A computer program executed by the integrated processing circuit 60A is stored in a memory 62A. The memory 62A is similar to the memory 62 shown in FIG. 3.

The technology of the disclosure may be used for measuring a roughness parameter of a large object, for example. Examples of the large object are a structure in a construction site and a large product manufactured in a factory, such as a vehicle.

What is claimed is:

1. A measurement system comprising:
a light source that emits irradiation light to be applied to a plurality of measurement points included in at least one evaluation region of a surface of an object;
an optical detector that receives reflected light returned from the plurality of measurement points and outputs a detection signal; and
a processing circuit that calculates and outputs a roughness parameter regarding an uneven shape of the at least one evaluation region, based on the detection signal,
wherein the processing circuit corrects the roughness parameter in accordance with an angle of incidence of the irradiation light incident on the at least one evaluation region, a measurement distance in the at least one evaluation region, or intensity of received light obtained as a result of the at least one evaluation region being irradiated with the irradiation light.

2. The measurement system according to claim 1, wherein:
the roughness parameter is one of an arithmetic mean height, root mean square height, developed interfacial area ratio, skewness, kurtosis, and root mean square slope in a two-dimensional region or one of the arithmetic mean height, root mean square height, skewness, kurtosis, and root mean square slope in a linear region.

3. The measurement system according to claim 1, wherein:
the at least one evaluation region includes a plurality of evaluation regions; and
the processing circuit corrects the roughness parameter in each of the plurality of evaluation regions in accordance with the angle of incidence of the irradiation light incident on a corresponding one of the plurality of evaluation regions.

4. The measurement system according to claim 1, further comprising:
an optical deflector that changes a direction of the irradiation light,
wherein the processing circuit controls an operation of the optical deflector.

5. The measurement system according to claim 1, wherein, before the irradiation light is emitted, the processing circuit calculates the angle of incidence of the irradiation light based on a result of distance measurement for the surface of the object.

6. The measurement system according to claim 1, wherein:
the processing circuit obtains correction data from a storage, the correction data being data that defines a correlation between an angle of incidence and a correction parameter;
the processing circuit determines a correction parameter based on the angle of incidence of the irradiation light and the correction data; and
the processing circuit corrects the roughness parameter based on the determined correction parameter.

7. The measurement system according to claim 6, wherein:
the correction data is stored in the storage by object attribute; and
the processing circuit obtains the correction data from the storage, based on an attribute of the object to be measured.

8. The measurement system according to claim 7, wherein the attribute of the object is at least one of a material, a proportion of the material, a size, a polishing method for the surface, or a product number of the object.

9. The measurement system according to claim 1, wherein:
when the incidence of angle is larger than a reference angle for correction, the processing circuit sets a greater correction amount for the roughness parameter as the angle of incidence is larger; and
when the incidence of angle is smaller than the reference angle for correction, the processing circuit sets a greater correction amount for the roughness parameter as the angle of incidence is smaller.

10. The measurement system according to claim 1, wherein the processing circuit outputs the roughness parameter which has not yet been corrected, as well as the corrected roughness parameter.

11. The measurement system according to claim 1, wherein:
the processing circuit includes first and second processing circuits;
the first processing circuit generates distance information on each of the plurality of measurement points, based on the detection signal;
the second processing circuit calculates the roughness parameter regarding the uneven shape of the at least one evaluation region, based on the distance information; and
the second processing circuit corrects the roughness parameter in accordance with the angle of incidence of the irradiation light incident on the at least one evaluation region.

12. A measurement method to be executed by a computer in a measurement system, the measurement system including a light source and an optical detector, the light source emitting irradiation light to be applied to a plurality of measurement points included in an evaluation region of a surface of an object, the optical detector receiving reflected light returned from the plurality of measurement points and outputting a detection signal, the measurement method comprising:
calculating and outputting a roughness parameter regarding an uneven shape of the evaluation region, based on the detection signal; and
correcting the roughness parameter in accordance with an angle of incidence of the irradiation light incident on the evaluation region.

13. A measurement system comprising:
a light source that emits irradiation light to be applied to a plurality of measurement points included in an evaluation region of a surface of an object;
an optical detector that receives reflected light returned from the plurality of measurement points and outputs a detection signal; and
a processing circuit that calculates and outputs a surface unevenness degree regarding an uneven shape of the evaluation region, based on the detection signal,
wherein the processing circuit generates a learned model by using, as training data, an angle of incidence of the irradiation light incident on a reference region, the detection signal, and the surface unevenness degree regarding an uneven shape of the reference region, and
wherein the processing circuit evaluates the surface unevenness degree in the evaluation region by using the learned model.

14. The measurement system according to claim 13, wherein the reference region is one of a plurality of different regions of the surface of the object or one of a plurality of virtual regions corresponding to a plurality of angles of incidence.

15. The measurement system according to claim 13, wherein the evaluation region is a two-dimensional region or a linear region.

16. The measurement system according to claim 1, wherein, based on the detection signal, the processing circuit sets the angle of incidence of the irradiation light incident on the at least one evaluation region, the measurement distance in the at least one evaluation region, or the intensity of received light obtained as a result of the at least one evaluation region being irradiated with the irradiation light.

17. A measurement system comprising:
a light source that emits irradiation light to be applied to a plurality of measurement points included in at least one evaluation region of a surface of an object;
an optical detector that receives reflected light returned from the plurality of measurement points and outputs a detection signal; and
a processing circuit that calculates and outputs a roughness parameter regarding an uneven shape of the at least one evaluation region, based on the detection signal,
wherein the processing circuit corrects a reference value used for evaluating the calculated roughness parameter in accordance with an angle of incidence of the irradiation light incident on the at least one evaluation region, a measurement distance in the at least one evaluation region, or intensity of received light obtained as a result of the at least one evaluation region being irradiated with the irradiation light, and
wherein the processing circuit outputs a result of comparison between the calculated roughness parameter and the corrected reference value.
